(19) United States
(12) Patent Application Publication
(10) Pub. No.: US 2003/0221162 A1
(43) Pub. Date: Nov. 27, 2003

(54) Meta-templates in website development and methods therefor

(76) Inventor: Mandayam Andampillai Sridhar, San Jose, CA (US)

Correspondence Address: IPSG, P.C., P.O. BOX 700640, SAN JOSE, CA, 95170-0640, US

(21) Appl. No.: 10/017,901

(22) Filed: Dec. 14, 2001

Related U.S. Application Data
(63) Continuation-in-part of application No. 09/531,980, filed on Mar. 20, 2000.
(63) Continuation-in-part of application No. 09/546,952, filed on Apr. 11, 2000.
(63) Continuation-in-part of application No. 09/765,058, filed on Jan. 16, 2001.
(63) Continuation-in-part of application No. 09/764,321, filed on Jan. 16, 2001.
(63) Continuation-in-part of application No. 09/995,006, filed on Nov. 26, 2001.

(51) Int. Cl. G06F 17/00

(52) U.S. Cl. 715/501.1

(57) ABSTRACT

A computer-implemented method for creating a plurality of webpages, which includes providing a meta-template having therein at least one of a tag and a variable. There is included providing a user data model. There is further included expanding the meta-template against the first user data model using a template expander at build time, thereby obtaining a template. There is further included expanding the template at run time against a data source, thereby obtaining codes implementing a webpage.

This application is a continuation-in-part of the following earlier filed commonly owned patent applications

1. “Systems for Developing Websites and Methods Therefor” by inventor M. A. Sridhar, application Ser. No. 09/531,980, filed on Mar. 20, 2000;

2. “Graph Theory Utilization in Website Development” by inventor M. A. Sridhar, application Ser. No. 09/546,952, filed on Apr. 14, 2000;

3. “Content Dereferencing in Website Development” by inventor M. A. Sridhar, application Ser. No. 09/765,058, filed on Jan. 16, 2001;

4. “Reverse Foreign Key Techniques in Website Development” by inventor M. A. Sridhar, application Ser. No. 09/764,321, filed on Jan. 16, 2001, and

5. “Techniques for automatic mapping between data fields and user data model data items in website development” by inventor M. A. Sridhar, application Ser. No. 09/995,006, filed on Nov. 26, 2001, all of which are incorporated herein by reference.

### BACKGROUND OF THE INVENTION

The present invention relates to techniques for developing websites for individuals and businesses. More particularly, the present invention relates to improved techniques for developing websites that are highly decoupled for maintainability and scalability while requiring little programming knowledge on the part of the website developers. Even more particularly, the present invention relates to website development and more particularly to techniques for efficiently controlling the rendition, look-and-feel, and for implementing repeatable codes in multiple webpages in a website.

Website development to date has been the province of the sophisticated computer programmers and technologists. A website that includes a front-end user interface, an application layer for performing business or logic operations, and a backend database engine typically requires one or more engineers well versed in programming languages to put together. The bulk of websites today has been built using two approaches: brute force and via some type of application development tool. In the brute force approach, each webpage is hand coded using an appropriate language such as Java, Perl, ASP, TCL, HTML, and the like. The programmer would create codes for interfacing with the user, for performing the required business/logic operation, and for interacting with the backend database. To speed up website development and alleviate some of the more tedious aspects of hand coding, an application development tool may be employed. Application development tools include such integrated development environments as Visual InterDev, PowerBuilder, Designer, and WebDB. However, a substantial amount of programming knowledge and sophisticated technical skills are still required to develop a website using one of the commercially available application development tools.

Under either approach, the high level of technical knowledge required has made it difficult for many to develop their own website. Even when an application development tool is employed, there are significant disadvantages. By way of example, there may be ongoing licensing costs if one of the proprietary application development tool engines is required for website operation and/or maintenance. Furthermore, a given application development tool may require a specific platform to run on, which in turn ties the website owner to a particular platform. Sometimes, a given application development tool may not be compatible with the legacy hardware/software that the business may employ prior to undertaking website development. The platform-specific nature of some application development tool also makes it difficult to enhance and/or scale the website to offer additional features and/or service additional customers. This is because such enhancement or scaling may exceed the capability offered by the application development tool itself. Still further, it is sometimes difficult to maintain websites developed via an application development tool since the proprietary engine may not be accessible for updates and/or changes if features need to be added and/or modified.

### SUMMARY OF THE INVENTION

The invention relates, in one embodiment, to a computer-implemented method for creating a plurality of webpages, which includes providing a meta-template having therein at least one of a tag and a variable. There is included providing a user data model. There is further included expanding the meta-template against the first user data model using a template expander at build time, thereby obtaining a template. There is further included expanding the template at run time against a data source, thereby obtaining codes implementing a webpage.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in one example, a diagram of a simple data schema that includes three tables in a relational database.

FIG. 2 illustrates a tree representing an automatically generated user data model.

FIG. 3 shows one of the steps in the process of creating a new model.

FIG. 4 illustrates a completed user data model tree in the left pane, with the automatically-generated HTML code in the right pane.

FIG. 5 shows, in accordance with one embodiment, a simplified flowchart illustrating the general steps involved in developing a website.

FIG. 6 shows an example of a data schema that involves many interrelated entities.

FIG. 7 shows, in one embodiment, an exemplary user data model that supports a more complex data view than that associated with FIG. 2.

FIG. 8 shows, in accordance with one embodiment, a simplified flowchart illustrating the general steps involved in developing a website having relatively complex data views.

FIG. 9 is a logical depiction of the possible relationships between two tables to facilitate discussion of the use of a graph model in helping the website developer specify the user data model.

FIG. 10 illustrates a simple link table that links to a Supplier table and a Part table for the purpose of illustrating the link table content dereferencing aspect of the present invention.

The steps of the computer-implemented method to dereference the content of a link table are shown in FIG. 11.

FIG. 12 shows an exemplary user data model for the example of FIG. 10.

FIG. 13 shows, in accordance with one embodiment of the present invention, the dereferenced version of link table 1000 of FIG. 10.

FIG. 14 shows, to facilitate discussion of another aspect of the present invention, a Supplier table, a Supplier-Part link table, and a Part table.

FIG. 15 shows, in accordance with one aspect of the present invention, a page view wherein the relationship information is presented in multiple columns.

FIGS. 16A-16D are exemplary tables to facilate discussion of one implementation of the drill-down via foreign key aspect of the present invention.

To facilitate discussion of another aspect of the present invention, FIG. 17 shows an exemplary simplified UDM 1710 for storing information pertaining to employees of a fictitious organization

FIG. 18 shows an exemplary data structure patterned after the UDM 1710 of FIG. 17.

FIG. 19 shows a simplified data input webpage 1910, representing an input webpage that may be employed by a user to input employee data.

FIG. 20 shows, in accordance with one aspect of the present invention, an encoding for the exemplary UDM 1710 of FIG. 17.

FIGS. 21a, 21b, and 21c shows, in accordance with one embodiment of the present invention, the HTML code segments employed for entering data into selected data input fields of FIG. 19.

To facilitate discussion of another aspect of the present invention, FIG. 22 shows an exemplary simplified UDM for editing purchase orders.

FIG. 23 shows an exemplary screenshot of a data editing webpage for editing a purchase order based on the UDM of FIG. 22.

Prior art FIG. 24 shows a template for generating a dynamic webpage implementable by the HTML codes.

FIG. 25 shows a conceptual view of the meta-template's role in the generation of a HTML webpage.

FIG. 26A shows an edit patron UDM.

FIG. 26B shows an edit book UDM.

FIG. 27 is a screen shot of the edit patron webpage (i.e., HTML) generated using the meta-template paradigm.

FIG. 28 is a screen shot of the edit book webpage (i.e., HTML) generated using the meta-template paradigm.

FIG. 29 is a screen shot of the edit patron webpage (i.e., HTML) of FIG. 27, generated after the meta-template paradigm is modified.

FIG. 30 is a screen shot of the edit book webpage (i.e., HTML) of FIG. 28, generated after the meta-template paradigm is modified.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one aspect of the present invention, user data models are automatically created from a furnished data schema. The data schema is generally implemented by tables of a relational database. In one aspect of the present invention, all possible user data models are automatically generated from the furnished data schema. In generating the user data models, links between tables in the data schema are inferred automatically. The user data models are then employed to automatically generate a plurality of data views, which are data output representations of the user data models. These data views may then be provided to the website developer for selection. The website developer may then choose one or more data views to be created. Once a data view is selected, the backend logic is then automatically generated, typically as codes such as SQL, Java, Perl, or TCL codes. The backend logic represents the logic employed to extract data from the database and to manipulate the extracted data to obtain the desired data output. Furthermore, the data view output for the selected data view is automatically generated in a generic webpage, which may then be customized by the website developer to fit the desired data presentation format.

As can be appreciated from the foregoing, website development is substantially simplified in that once the data schema is furnished, the data views are automatically created for selection by the website developer. Selecting the desired data views (e.g., by clicking on selected ones in the list of all possible data views) causes the backend logic and front-end data view output to be automatically generated for each of the selected data views. At this point, all the website developer needs to do is to customize the generic webpages that contain the data view outputs, and website development is substantially done.

In another aspect of the present invention, it is recognized that some relational database may be so voluminous and/or the relationship between tables in such databases may be so complex that the number of possible combinations of user data models may be very large. Even if there is sufficient computing power to generate such large combinations in a reasonable amount of time, it is recognized that the website developer may be overwhelmed with the choices available, making the whole system less than user friendly. In this case, it is preferable that the website developer be furnished with a tool to edit his own user data model in order to more directly specify the data view desired. From the developer-specified user data model, links may be inferred automatically and a data view may be automatically created therefrom. For this data view, the backend logic may also be automatically generated, and the data view output automatically generated as well on a generic webpage. Again, the website developer may modify the generic webpage as necessary to conform the output to the desired data presentation format.

Whether the user data model is automatically generated or specified by the website developer, the present invention simplifies the process of building a website to nonprogramming steps to allow websites to be developed even by people who have only modest technical skills. Furthermore, the process is platform-independent in that the resultant website does not depend on any particular proprietary engine of any application development tool for operation and/or maintenance. This is because the backend logic is preferably generated as platform-independent codes (such as Java, Perl or TCL). The data view output is also generated using platform-independent interfaces such as webpages. Accordingly, scalability, maintainability, and cross-platform compatibility are ensured. The process does not, however, preclude the use of platform-specific technologies such as C/C++ or Microsoft ASP, if such is desired.

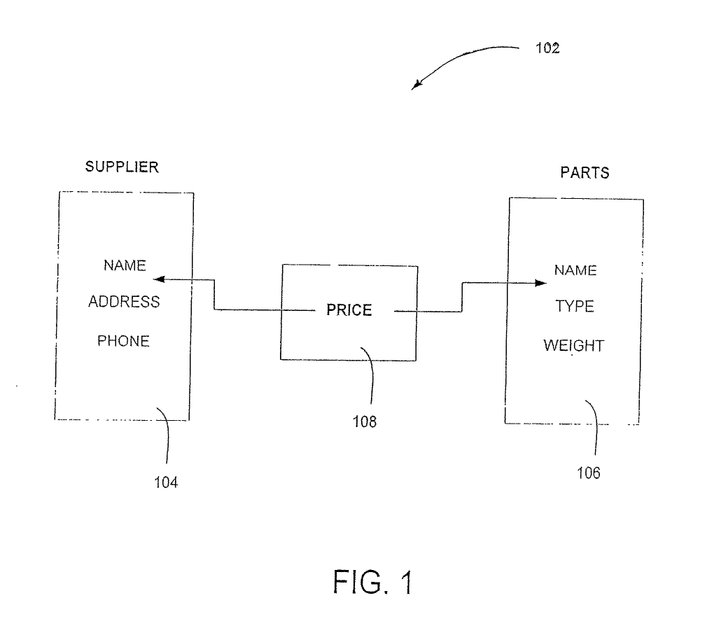

These and other advantages and features of the present invention may be better understood with reference to the figures and discussion below. FIG. 1 shows, in one example, a diagram of a simple data schema 102 that includes three tables in a relational database. In general, a data schema may be thought of as the backend relationship among data tables in a relational database. In the present example, data schema 102 represents a data schema that models the relationship between a supplier and parts for a fictitious purchaser of such parts. As such, a supplier table 104 having attributes such as “name” “address” and “phone” are shown, along with a part table 106, which has attributes such as “name” (for name of the part), type, weight. Of course other attributes are also possible, although only a few are shown here to simplify the discussion.

These two tables 104 and 106 are linked by a link table 108, which may contain, for example, a price attribute. Link table 108 describes the attributes of the relationship between supplier and parts. For example, link table 108 may answer questions such as “I'm interested in knowing the price at which specified suppliers will sell a specific part.” There may also be other link tables that describe other attributes of the relationship between the supplier and the part. For simplicity, other link tables are not shown. The data schema of FIG. 1 is conventional and is familiar to one skilled in the relational database art.

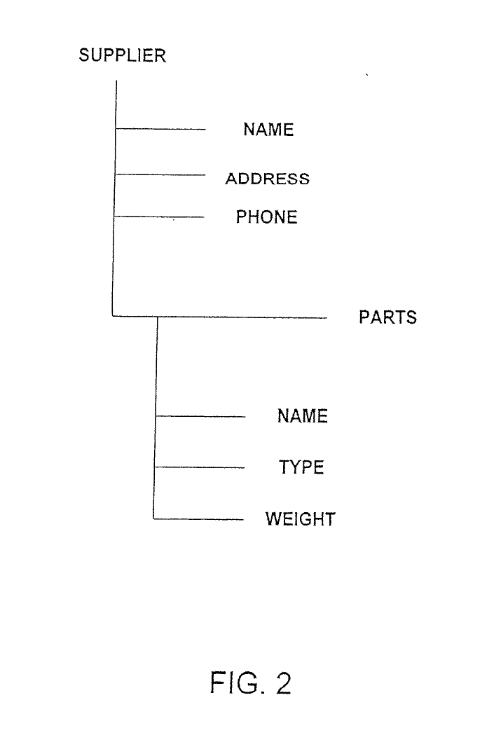

From data schema 102 of FIG. 1, a set of user data models may be specified. In one embodiment, all possible user data model combinations are generated. To automatically generate a user data model, a tree is created with the root node corresponding to a primary database table, and a child node corresponding to a related table. In the example of FIG. 1, the root node is the supplier 104 and the child node is the part 106. Such a tree is shown in FIG. 2. Note that under the root node “Supplier,” all the fields of supplier table 104 are shown under the root node (such as “name” “address” and “phone”). Under the child node “Part”, all the fields of the part table 106 are shown (such as “name,” “type” and “weight”).

At this point, it is possible (at least theoretically) identify every possible user data model that can be constructed from a given schema. Three examples illustrate this. In the first example, there is one model for each table in the database. Such a model includes just the data elements (columns) of the table in question. In the second example, there is one model for each pair of “related” tables. Two tables are deemed “related” if there is a reference from one to the other in the database. In the third example, there is one model for each three “related” tables containing at least one chain of relationships among them.

Larger numbers of related tables may be analyzed similarly. However, the number of possible models soon becomes very large. The database schema may be viewed as a graph whose nodes are tables and whose edges are relationships between tables. This perspective facilitates the application of standard graph-theoretic algorithms for enumerating the data models as well as for generating the back-end code.

To illustrate the mechanism of constructing the Java and SQL code for handling backend logic, the supplier-parts data schema may be employed as a running example. Each database table is represented by a Java class, and an instance of such a class contains a record of the table. In addition, a second Java class encapsulates the database logic and the SQL code.

For a single table, the SQL code for retrieving, storing and modifying the data in the table can be automatically created and embedded into the Java classes. For instance, for the above supplier-parts example, the code below shows parts of the Java classes corresponding to the Part table. Note that reference line numbers have been added to the codes for ease of reference. In the production codes, these reference numbers do not exist.

```
1  /**
2  * Construct an instance of Part from an explicit list of
3  * parameters.
4  */
5  public Part
6  (
7  int Id
8  , java.lang.String Part_number
9  , java.lang.String Name
10  , int weight
11  ) {
12  _valueHash = new Hashtable( );
13
14  _valueHash.put (“Id”, new Integer (Id));
15  _valueHash.put (“Part_number”, Part_number);
16  _valueHash.put (“Name”, Name);
17  _valueHash.put (“weight”, new Integer (weight));
18  }
19  public Vector getObjects
20  (String whereClause, String otherTableNames, DbConnection
21  connection) throws SQLException {
22  String fieldString = “”
23
24  + “ Part.Id”
25  + “, Part.Part_number”
26  + “, Part.Name”
27  + “, Part.weight”
28  String fromClause = “Part”;
29  if (otherTableNames != null && otherTableNames.length( ) > 0)
30  fromClause += “, ” + otherTableNames;
31  String sqlString = “select ” + fieldString + “ from ” + fromClause;
32  if (whereClause != null && whereClause.length( ) > 0)
33  sqlString += “ where ” + whereClause;
34  QueryResponse q = connection.executeSql (sqlString);
35  ResultSet r = q.resultSet( );
36  Vector v = new Vector( );
37  _seenIdsSet.clear( );
38  while (r.next( )) {
39  Integer primaryKey = new Integer (DbUtils.getint (r, “Id”));
40  if (!_seenIdsSet.contains (primaryKey)) {
41  v.addElement (buildFromResultSet (r));
42  _seenIdsSet.add (primaryKey);
43  }
44  }
45  q.close( );
46  return v;
47  }
48
49  /**
50  * Save the given object into the database via the given connection. If
51  * the object has an id of zero, it is treated as a request to insert a
52  * new record into its table. Otherwise, this is treated as an update
53  * request. In either case, this method returns the id of the inserted
54  * or updated object.
55  */
56  public int saveToDatabase (DbObject object, DbConnection
    connection)
57  throws java.sql.SQLException {
58  int id = object.id( );
59  if (object.id( ) != 0) {
60  modifyDatabaseRecord (id, object, connection);
61  } else {
62  String sqlString = “insert into Part (”
63
64  + “Id ”
65  + “,Part_number”
66  + “,Name”
67  + “,weight”
68  + “) values (”
69
70  + “” +
71  “Part_sq.nextval”
72  + “,” + DbUtils.sqlRep ((java.lang.String)
object.valueOfAttribute (“Part_number”))
73  + “,” + DbUtils.sqlRep ((java.lang.String)
object.valueOfAttribute (“Name”))
74  + “,” + DbUtils.sqlRep ((Integer)
          object.valueOfAttribute (“weight ”))
75  + “)”;
76  connection.beginTransaction ( );
77
78  QueryResponse q = connection.executeSql (sqlString);
79  q.close( );
80
81
82  // Get the id of the newly-inserted record, and set it as the id
83  // of the object
84  sqlString = “select Part_sq.currval from dual”;
85  QueryResponse q1 = connection.executeSql (sqlString);
86  ResultSet r = q1.resultSet( );
87  if (r.next( ))
88  object.setId (r.getInt (1));
89  connection.commitTransaction ( );
90  q1.close( );
91  }
92  return object.id( );
93  }
```

The code lines 7-10, 14-17, 24-27, 64-67, and 72-74 illustrate places where the generator introduces lists of attribute names corresponding to the actual attributes of the table. Thus the process for constructing the Java classes corresponding to the database tables is as follows. First, analyze the database schema and create a list of tables, and a list of attributes for each table. Thereafter using a pre-created Java class template, create two classes for each table in the list, by replacing occurrences of the table name and list of attributes by the corresponding values. This accounts for both the Java code and the embedded SQL code. Thereafter, outputting the resulting Java classes.

There is created “generic” back-end Java code that relies on the automatically-generated Java classes for correct operation with multi-table user-data models. The code is generic, in that its structure does not rely either on a particular table structure or a particular user data model structure. It merely assumes that the user data model is laid out as a tree, as shown in the earlier diagram. Generally speaking, this code operates as follows:

First, inspect the tree structure of the user data model, and with each non-leaf element of the tree, associate the two Java classes corresponding to the table for which the node is created.

To retrieve data associated with the model, traverse the tree from root to leaf. For each non-leaf node encountered along the way, invoke the data retrieval methods of the corresponding Java classes, and accumulate the results in an internal data structure. Return this data structure when the traversal is complete.

To store data associated with the model, traverse the tree from root to leaf, and insert the associated data into the database. Data storage is complicated by the fact that the foreign-key dependencies in the database are not necessarily consistent with the ordering of data elements in the tree. Consequently, it is desirable to compute, a priori, a topological sort ordering of the tables, so that non-dependent tables occur before dependent tables in the ordering. (Topological sorting is a widely-known algorithm in graph theory, and we have applied it to database schemas.) During data storage, it is desirable that data is inserted in tables according to their order of occurrence in the topological sort ordering.

As indicated earlier, determining the collection of all user data models to be generated is simply a matter of constructing a graph model for the database schema and identifying all 2-table, 3-table (or multi-table) relationships in which there is at least one chain of dependencies among the tables. Determining such table groups is a matter of using a suitable graph algorithm (e.g., breadth-first search). For each such group, construct all the possible user data model trees and present them as possibilities to the user.

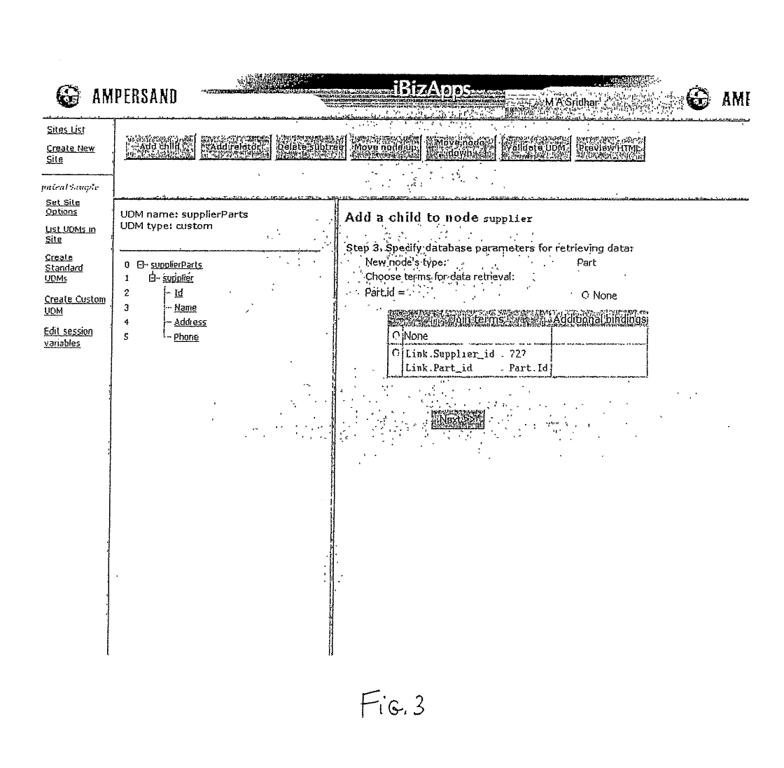

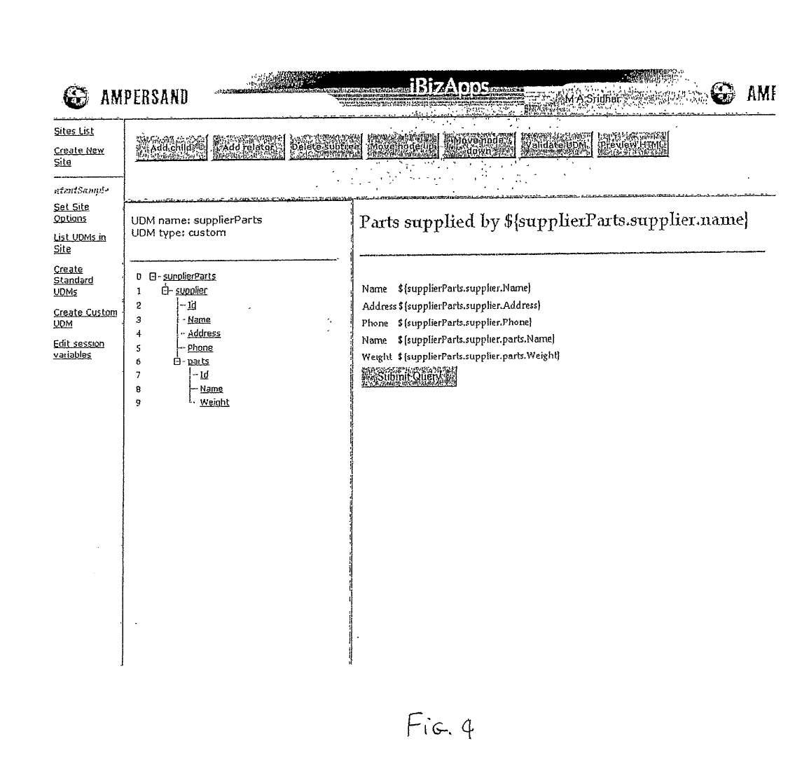

FIG. 3 shows one of the steps in the process of creating a new model. The schema used in creating this model is the same as that of FIG. 1. This particular step is an intermediate step in adding a child named “part” to the node named “supplier”, and highlights the fact that the system has automatically determined the identity of the linking table and therefore the possible “join terms” in the SQL to be generated.

FIG. 4 illustrates a completed user data model tree in the left pane, with the automatically-generated HTML in the right pane.

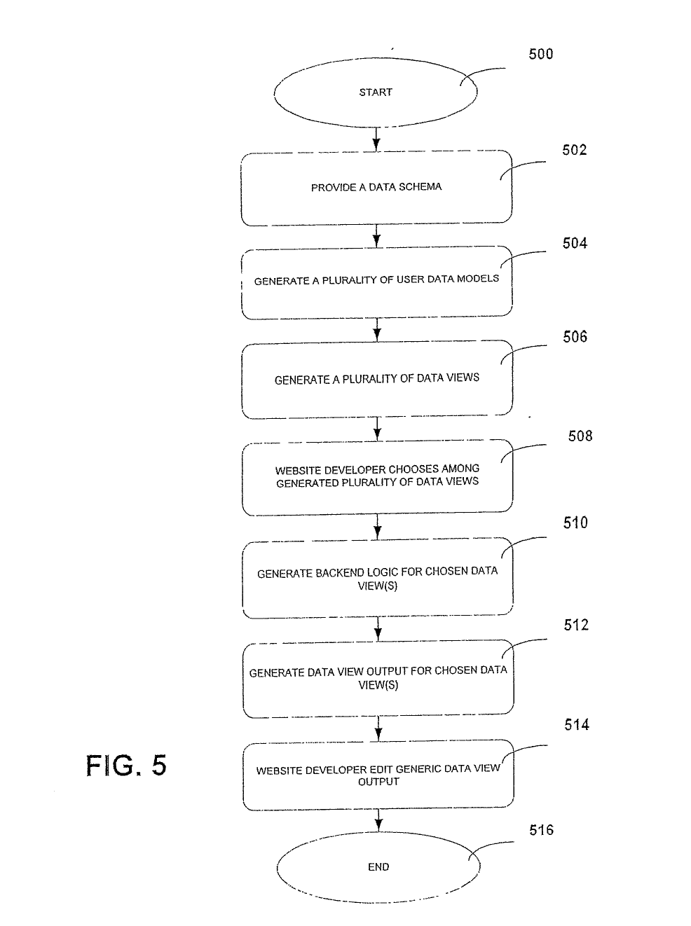

FIG. 5 shows, in accordance with one embodiment, a simplified flowchart illustrating the general steps involved in developing a website. In step 502, a data schema is provided. As mentioned, this data schema represents tables in a relational database from which the user wishes to obtain one or more specific data views in one or more webpages or other output medium. In step 504, a plurality of user data models are automatically generated. In one embodiment, the user data models generated in step 504 represents all possible combinations of data views. Note that as the term is employed herein, automatic generation denotes the fact that the generation of the thing generated is performed using computer-implemented logic instead of using a manual (whether by hand or computer-assisted) method. Automatic generation does not preclude (by also does not require) the possibility that the website developer may issue one or more commands to start the generation of the thing generated.

In step 506, data views are generated from the user data models generated 30 in step 504. In step 508, the website developer chooses from among the data views generated in step 506 one or more desired data views. By way of example, the data views generated in step 506 may be presented in a list form and the website developer merely checks off the desired data views from the list. Once the desired data views are ascertained, links may be inferred from the user data models associated with the desired data views, and the backend logic therefor may be automatically generated (step 510). In step 512, the user interface front-end is generated. In this step, the data view output for a selected data view may be created on one or more generic webpages. Note that although the webpage example is employed herein to simplify the discussion, it should be noted that the data view output may be created (and subsequently modified by the website developer) in any suitable and/or specified user-interface front end. Examples of suitable user-interface front ends include Internet-enabled telephones, Wireless Application Protocol-enabled cellular phones, Internet-enabled handheld computers, Internet-enabled two-way pagers, and the like.

In step 514, the website developer may edit the generic webpage output to conform the data to a desired data presentation format (for example to enhance aesthetics, readability, or user-friendliness).

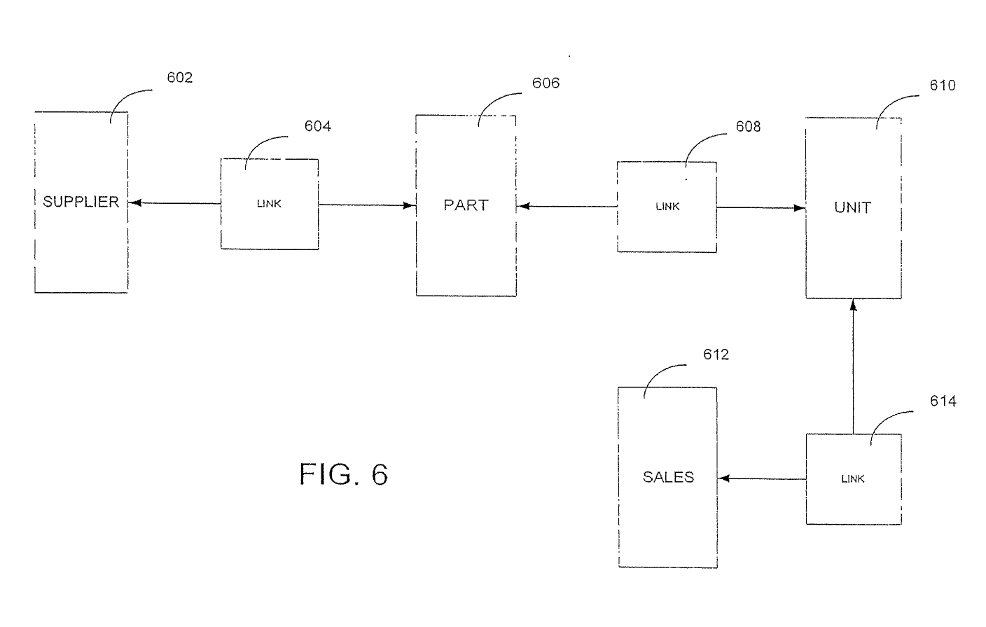

When a more complex data schema is involved and/or where the relationship among multiple tables is complex, it may be desirable to receive the user data model directly from the website developer instead of generating all possible user data models for the website developer to choose. FIG. 6 shows an example of a data schema that involves many interrelated entities. In the example of FIG. 6, one may want to keep track of sales by unit, with each unit having multiple parts and each part supplied by multiple suppliers. If the user desires a view that shows all sales 614 by a particular supplier 602 and also the parts (606) which contributes to the sales. Automatically generating all user data models for the data schema of FIG. 6 may result in a massive list of user data models and data views from which the website developer must search through and select the desired ones. In this case, the provision of an editing tool that allows the website developer to specify the exact user data model associated with the desired data view may be highly useful.

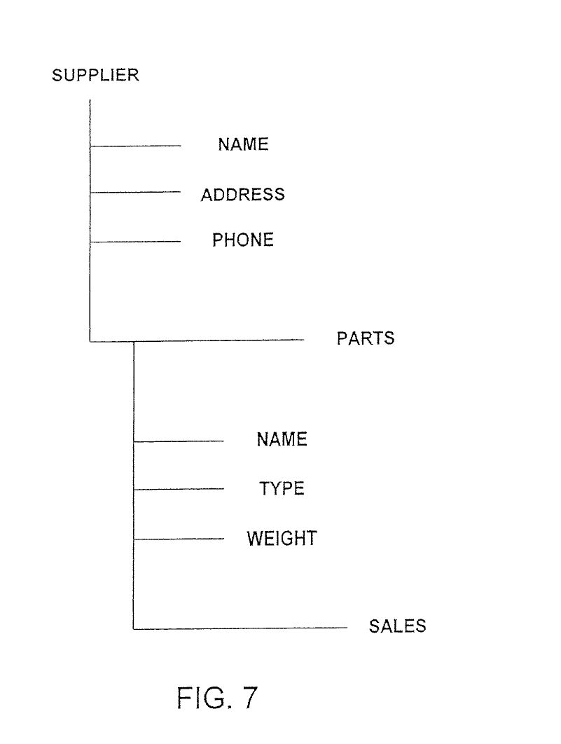

FIG. 7 shows, in one embodiment, an exemplary user data model that supports a more complex data view than that associated with FIG. 2. In FIG. 7, the supplier 702 may be, for example, AC-Delco and the part 704 may be, for example, radios, speakers, cassette decks, and the like. Sales 706 reflects the sales associated with the part 704 from the supplier 702. With a user data model editing tool, the user data model hierarchy of FIG. 7 may be input by the website developer. From the supplied user data model, the system may then automatically infer links to create the backend logic (e.g., the the SQL or Java codes). Thereafter, the user interface front-end is generated for the data view associated with the supplied user data model.

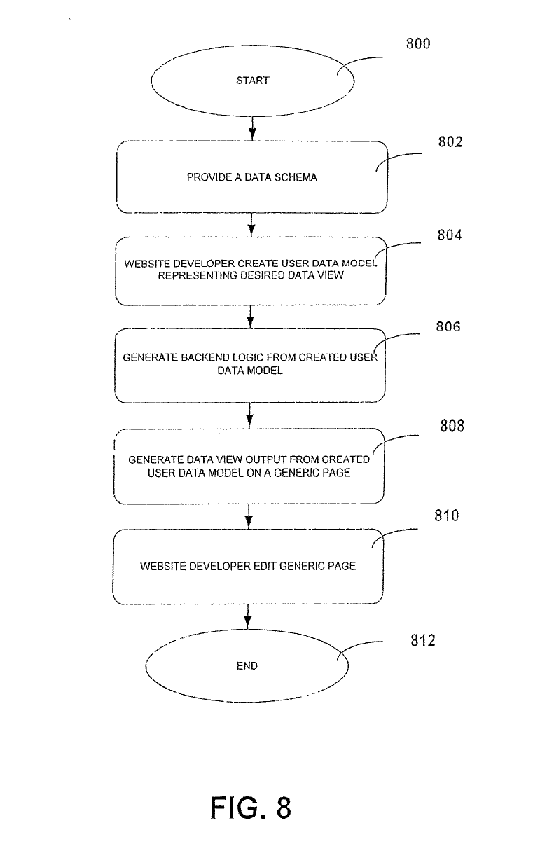

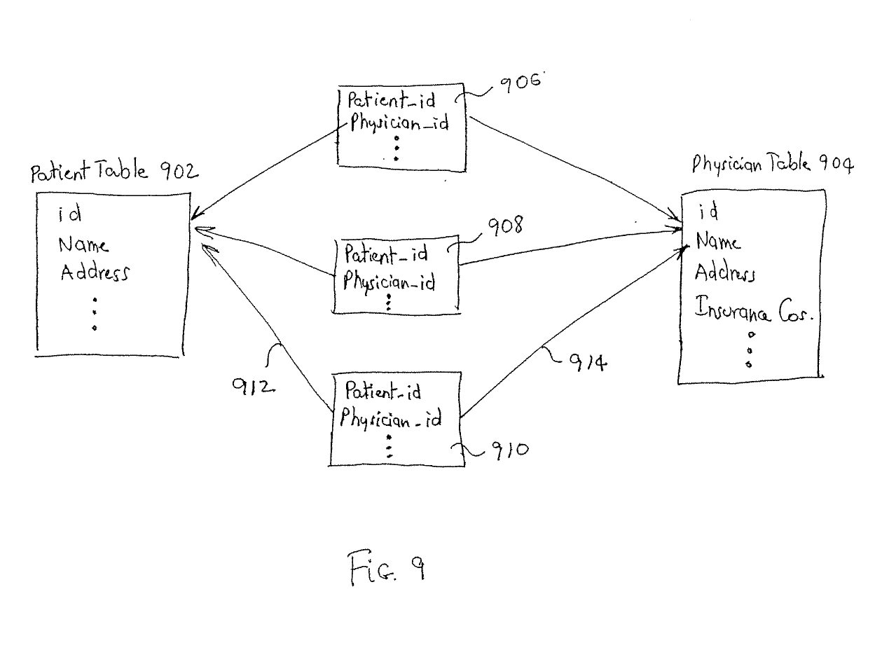

FIG. 8 shows, in accordance with one embodiment, a simplified flowchart illustrating the general steps involved in developing a website having relatively complex data views. In step 802, a data schema is provided. In step 804, the website developer may employ an editing tool to create a user data model that represents the desired eventual data view.

In step 806, links may be inferred from the user data model furnished by the website developer, and the backend logic therefor may be automatically generated. In step 808, the data view output is generated. In this step, the data view output for a data view may be created on one or more generic webpages. In step 810, the website developer may edit the generic webpage output to conform the data to a desired data presentation format (for example to enhance aesthetics, readability, or user-friendliness).

As can be appreciated from the foregoing, the invention facilitates the development of websites without requiring the website developer to have in-depth programming knowledge or sophisticated technical understanding of website development. Even for those having a high level of technical sophistication, the present invention simplifies the website development process in that it essentially reduces website development to a series of choices to be made (e.g., choice of data views in the case where all data views are generated) or simple editing of the user data model that represents the desired eventual data view. The steps in between, i.e., the creation of the backend logic that interfaces with the database and manipulates the data as well as the outputting of the data view output on a user-interface front end, are automatically performed for the website developer. The website developer remaining task is then to beautify the generic data view output to conform to his desired data presentation format.

This is in contrast to the prior art approach wherein the website developer is engaged to write programming codes for each data view desired. Whenever a new data view is desired, new codes must be written and new HTML pages must be coded. In the present invention, the addition of a new data view involves choosing the desired data view from the list of all possible data views and then beautifying the result (in the case of relatively simple data relationship) or specifying the user data model representing the desired eventual data view and then beautifying the result (in the case of more complex data relationship). In either case, the burden on the website developer is substantially lower.

Furthermore, the invention facilitates the creation of a website that is highly decoupled and platform independent. This is in contrast to the platform-dependent, black-box nature of prior art application development tool environments. In the present invention, the backend logic is generated independent of the front-end user interface. The backend logic is preferably generated using a cross-platform language to allow the developed website to be deployed on a wide variety of computers and operating systems, which reduces the possibility of incompatibility with the customers' legacy computing resources and promotes maintainability. The front end user interface is decoupled from the backend logic and is also generated in a language that is also platform-independent (such as HTML or XML).

In accordance with one aspect of the present invention, it is recognized that the complexity and sheer number of possible relationships among records of various data tables in a typical commercial or industrial database present difficulties to website developers when they are trying to come up with the desired user data model. Specifically, the user data model provided by the website developers needs to accurately reflect a subset of all possible relationships between data records and/or data tables of the supplied data schema. If a part of the specified user data model specifies a relationship that is not enabled by the provided data schema, this erroneous specification will prevent the desired data view from being generated. In a highly complex database with a large number of data tables, each of which may have numerous records and fields specifying specific relationships with other records and fields of other data tables, the specification of an accurate user data model is not a trivial exercise for the website developer.

From this recognition, it is realized that website developers need assistance in developing user data models. In particular, website developers can benefit from a tool that allow them to specify user data models in such a way that is both user-friendly and accurate. In accordance with one aspect of the present invention, it is realized that the amount of effort and the chance for error can be reduced if the website developer is furnished, during the user data model specification process, with an automatically extracted list of possible relationships between a given data table under consideration and the data tables with which it is related per the furnished data schema. From these possible relationships, which are automatically extracted from the furnished data schema, the website developer can select the desired relationship as a way to develop the user data model. Thus, the invention serves to both reduce the effort required on the part of the website developer to accurately recognize possible relationships from the supplied data schema (by automatically extracting the possible relationships from the data schema and presenting them to the website developer) and to eliminate error in relationship specification (by limiting the choice to only the list of possible relationships presented). Furthermore, once the desired relationship is selected from the list of possible relationships, the SQL or formal query statements can be automatically generated for the selected desired relationship, thus further reducing the effort required to generate such statements.

Although there are many ways to extract possible desired relationships between data tables, graph theory is employed in a preferred embodiment. Graph theory by itself is not new. In fact, graph theory is a well studied domain and has been around for sometime, although not employed in the manner disclosed herein. By way of example, the references G. Chartrand and L. Lesniak, Graphs and digraphs, Wadsworth, Inc., 1986, S. Even, Graph algorithms, Computer Science Press, 1979, A. Aho, J. Hopcroft and J. Ullman, Design and analysis of computer algorithms. Addison-Wesley, 1974, which are incorporated by reference, may be reviewed for background information regarding graph theory.

In the present invention, graph theory is employed to model the relationships between data tables of the provided data schema and to extract the possible relationships between a data table and its related data tables for use by the website developer during the steps of the user data model specification process. Generally speaking, a graph has at least two main components: a node and a link. In the supplied data schema, data tables are represented by nodes. Links (also edges and/or arcs although the disclosure employs the term “link” generically) may be employed to model the foreign key/primary key relationships between records of a table and records of its related tables. Links may be nondirectional, unidirectional or bidirectional, and may be either weighted or unweighted. Other variations also exist for the links.

After modeling the data schema as a graph, all the nodes and links pertaining to a particular data schema may then be stored in a graph data structure such as an adjacency list or an adjacency matrix. The choice of adjacency list versus adjacency matrix representation is determined by the particular algorithm we wish to execute, since this choice largely determines the run-time efficiency of the algorithm. Additional information pertaining to graph data structures may be obtained from the above references, which are incorporated by reference. During the user data model specification process, an appropriate graph algorithm (such as breadth-first search) can be employed to mine the graph for possible relationships between a particular data table and other data tables of the data schema, and to present those possible relationships to the website developer for selection. Breadth-first search is a standard algorithm which forms the basis for solving many well-known graph problems. After selection is performed, the SQL statements may be generated based on the identity of the nodes/tables selected, as well as the links that are associated with these tables.

To facilitate discussion, FIG. 9 is a logical depiction of the relationships between a patient table 902 and a physician table 904. As can be seen in FIG. 9, at least three relationships are possible between a patient and a physician. To a given patient, a given physician may be a referring physician (logically represented through table 906), a primary physician (logically represented through table 908), or a secondary physician (logically represented through table 910). A patient may have multiple referring or secondary physicians, and thus the actual relationships may be even more complex.

These tables are modeled in the graph as nodes. Further, each table/node (e.g., secondary table 910) has a relationship with a related table/node (e.g., patient table 902 or physician table 904) that is specified by a link (e.g., link 912 or link 914 respectively). In general, the links associated with a given table can be ascertained by examining its foreign key relationships. Recall that a foreign key/primary key pair is the mechanism by which a database designer specifies the relationship between two tables. By way of example, when the secondary table 910 is created during the process of database generation by the database designer, a foreign key may be specified to point to patient table 902 and another foreign key may be specified to point to physician table 904. At each of patient table 902 and physician table 904, there is a corresponding primary key that holds the value referenced by the foreign key in the secondary table 910. These foreign key/primary key relationships are modeled as links in the graph. On the logic depiction of FIG. 9, line 912 represents one such link between the secondary physician table 910 and the patient table 902.

Since link tables (such as referring physician table 906, primary physician table 908, or secondary physician table 910) define the relationships between other tables (such as patient table 902 or physician table 904), a convention needs to be developed to identify whether a particular table in the graph is a link table. In accordance with one aspect of the present invention, a link table is understood to be any table that has two or more foreign keys pointing to other tables. If such a table is encountered, it is understood to be a possible relationship alternative and therefore a possible candidate for selection by the website developer.

With reference to the example of FIG. 9, during the user data model creation process, the three alternative relationships between patient table 902 and physician table 904 may be extracted from the graph and presented to the website developer. From this list of three possible alternative relationships, the website designer may choose one (e.g., secondary). The corresponding portion of the user data model is then created from the chosen relationship and the SQL statements may then be formed. Exemplary SQL statements may be “secondary.patient_=patient.id” and “secondary.physician_id=physician.id” These SQL equalities reflect the relationships specified by links 912 and 914 in FIG. 9, which links and nodes 902/904 are extracted from the graph employed to model the data schema of FIG. 9.

In accordance with another aspect of the present invention, the graph model of the data schema may be leveraged to help enforce the data integrity aspect of the foreign key dependency. Data integrity in this context refers to the requirement that a data record in the table that contains the foreign key(s) must have a counterpart in the table that contains the primary key(s). Data integrity is relevant, for example, when a record needs to be added to the secondary physician table 910. When a record is added that includes secondary key(s), it is a requirement that there already be a record in the table associated with the primary key(s) so that the foreign keys can refer to valid values. To put it differently, the order in which records are added matters when foreign key/primary key relationships are involved.

In a complex data schema with complex interrelated foreign key/primary key relationships, it is difficult for programmers to keep track of the order by which records need to be added to support data integrity. At the front end, the user is typically unaware or uninterested in the requirements data integrity for all possible foreign key/primary key relationships. Accordingly, a technique needs to be devised to allow records to be inserted into the tables of the data schema in the correct and user-friendly manner.

In accordance with one aspect of the present invention, the same extracted graph can be employed to support the data integrity requirements of the foreign key/primary key relationships. More specifically, a topological sort may be employed on the graph to extract a map, which represents the ordering of tables according to their foreign key/primary key relationships. Topological sort is well known and additional information may be obtained from references such as the references by Aho, Hopcroft and Ullman listed above, which is incorporated by reference herein.

This map may be incorporated with the business logic that is responsible for record insertion such that the tables associated with the primary keys are always handled prior to the tables associated with the secondary keys for any given foreign key/primary key relationship. One way to employ the map is to provide a numbering scheme that associate a priority number with each table such that the table(s) with the higher priority numbers are associated with the primary keys and are handled first before the tables with the lower priority numbers (which are associated with the secondary keys) are handled. Thus, records may now be inserted in any order, and at the backend, they will be handled in the appropriate manner to satisfy the requirements of data integrity.

To further discuss the use of topological sorting, consider the example of FIG. 9. Because of the foreign key constraints among the tables, it is important that a record be inserted into the table 906 (linking patient and physician, representing the “referring physician” relationship) only after corresponding records have been inserted into (or are already available in) the patient and physician tables 902 and 904 respectively. When a topological sort order is constructed, it assigns a numerical ranking, or “priority,” to each table, such that inserts into a higher priority table must precede those into a lower priority table. One of the possible rankings in this example would be to assign the ranks 10 and 9 for the patient and physician tables(902 and 904 respectively), and the ranks 8, 7 and 6 to the three linking tables (906, 908 and 910). When the user of the website requests to insert data into these three tables, he does not need to specify the order of insertion. The back-end logic, however, first consults the pre-constructed ordering, determines that the patient and physician tables have higher priority, and (correctly) inserts into those tables before inserting into the linking table.

The graph model of the data schema can also be leveraged to detect the presence of loop errors. A loop error occurs when an entity refers to itself indirectly in the database (i.e., a circular reference) and is almost always an error in the definition of the data schema. In a large, complex database, manual detection of loop errors is very difficult and tedious, and many loop errors may escape the manual detection process to wreak havoc after product release. In accordance with another aspect of the present invention, once the data schema is modeled by nodes and links of the graph, a cycle detection algorithm may be employed to detect loops in the graph. This is another innovative application of the graph theory to the data schema. Exemplary loop detection algorithms applicable to graphs for this purpose include depth-first traversal, breadth-first traversal, and the computation of biconnected components, and details pertaining thereto may be found in the references listed above, which are incorporated by reference.

In accordance with another aspect of the present invention, there is provided a computer-implemented method for automatically dereferencing the content of a link table so as to present the content of the link table in a more readily understandable manner to either the website developer or the end user. As mentioned earlier, a link table specifies relationships among attributes of other tables of the database. In constructing the schema for the database, the database designer already devoted a great deal of attention and thoughts to the data elements and their relationships. By way of example, the database designer may designate certain tables to fulfill the role of link tables (by virtue of their foreign key relationships with the primary keys of other tables). These relationships are captured, in the context of the invention herein, in the link tables.

However, such relationships are typically not readily perceptible to the website developers since data fields in records of the link tables are represented, as is known to those familiar in the relational database art, by the record IDs of the records in the related tables. While such representation is efficient from the standpoint of the relational database management system, it is far from being user-friendly to human users. Accordingly, the full benefit of the extensive thought process and efforts of the database designer is often denied to the website developer, who must build the web site in view of the supplied data schema of the database.

In the past, dereferencing the content of a link table typically requires custom programming. In a typical case, a custom program is written for a specific link table after the underlying relationships between the foreign keys of the link table and the primary keys of the related tables are understood. The custom program dereferences the cryptic record ID number contained in the data fields of the data records of the link table. Thus, theoretically speaking, it is possible to dereference the content of link tables via custom programs. In practice, however, dereferencing of link tables via custom programs is typically performed, if at all, on a very limited basis since custom programming is expensive and time consuming. Accordingly, there is a need for a computer-implemented method for automatically dereferencing the content of link tables which avoids the expense and time-consuming aspects of the custom programming approach.

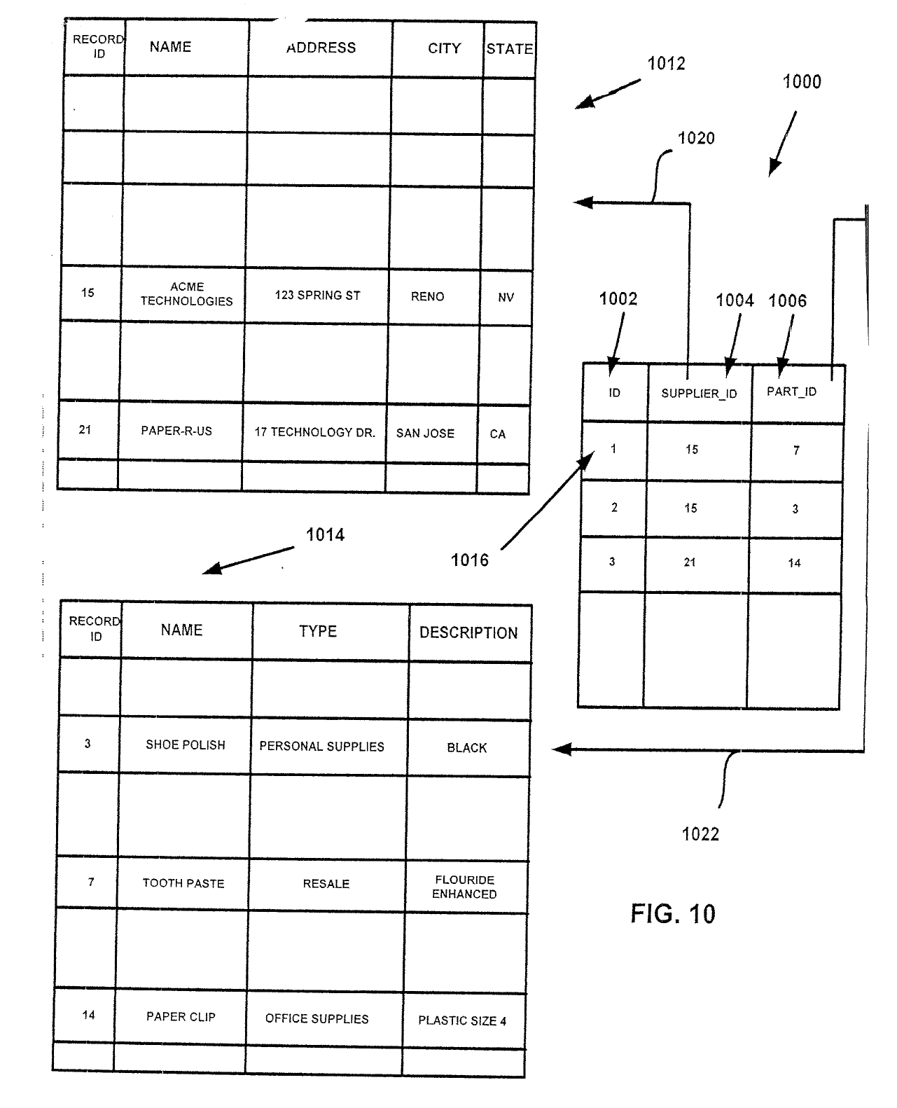

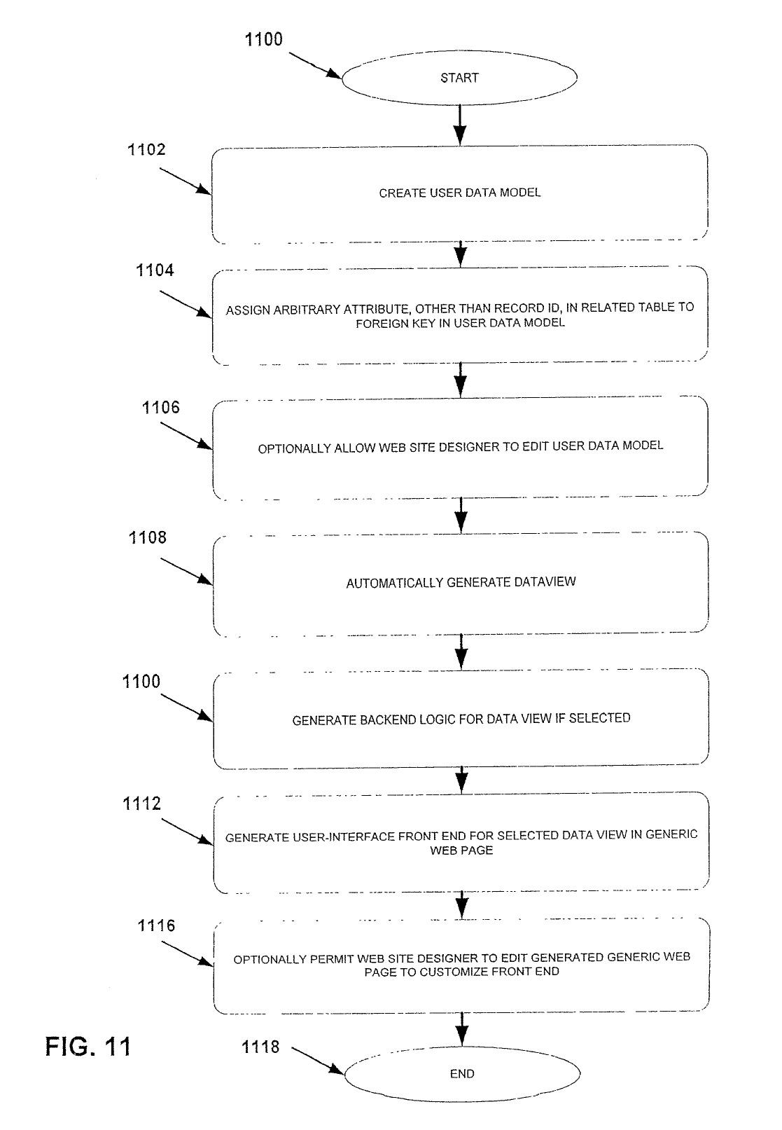

Details of the automatic dereferencing aspect of the present invention may be better understood with reference to the figures that follow. In FIG. 10, a simple link table 1000 is shown having three attributes: a RecordID attribute (1002), a Supplier_ID attribute (1004) and Part_ID attribute (1006). In the example of FIG. 10, the Supplier_ID attribute 1004 is a foreign key attribute that indicates a relationship between link table 1000 with Supplier table 1012. The Part_ID attribute 1006 is likewise a foreign key attribute that indicates a relationship between link table 1000 with Part table 1014. Each record of link table 1000 is also assigned a record ID number, which is represented by the attribute recordID.

A certain link record of link table 1000, such as the record with the RecordID=1 (indicated by reference number 1016 in FIG. 10) thus indicates a relationship between a particular supplier with a particular part and may be employed to ascertain, for example, the parts that a particular supplier supplies or the suppliers that supply a particular part. As shown in FIG. 10, the data fields corresponding to both the Supplier_ID attribute and the Part_ID attribute are represented in each record of link table 1000 by numerical values which correspond to the record numbers in the related tables. For the record whose RecordID=1 (reference number 1016 in FIG. 10), the Supplier_ID attribute field has a value of 15 and the Part_ID attribute field has a value of 7. Thus, this link record indicates that the part contained in record #7 of part table 1014 is supplied by the supplier identified in record #15 of supplier table 1012.

If a website developer were to look at link table 1000 in isolation, little information regarding the relationships between attributes of supplier table 1012 and part table 1014 could be ascertained. To most website developers, the number 15 in the Supplier_ID attribute field of link record #1 and the number 7 in the Part_ID attribute field of link record #1 mean little. If the content of link table 1000 could be automatically dereferenced using a computer-implemented method, the relationships between these data entities, which relationships were carefully thought out by the database designer, would be more understandable to the website developer and be more useful to the website developer in the task of manipulating the data and presenting the result to the end user. Furthermore, the speed and relatively low cost of a computer-implemented method for automatically dereferencing link tables would render the possibility of dereferencing link tables for the use by the website developer a more practical proposition, from both time and cost perspectives.

One of the difficulties of automatically dereferencing the content of the link table is to ascertain which attribute of the related table (such as supplier table 1012) a particular foreign key refers to. In the example of FIG. 10, although the value 15 in the Supplier_ID attribute field of link record #1 (reference number 1016 in FIG. 10) indicates a relationship with the record #15 in supplier table 1012, it is unclear looking at link table 1000 which particular attribute (name, address, city, or state) of supplier table 1012 would be relevant. Indeed, the information required to ascertain which attribute of the related table a particular foreign key refers to is not encapsulated within link table 1000.

In one embodiment of the present invention, the computer-implemented method simply arbitrarily assigns one of the attributes of the related table (e.g., supplier table 1012 of FIG. 10) to the foreign key attribute in the link table (e.g., link table 1000). In one specific embodiment, the computer-implemented method assigns the first attribute that follows after the recordID attribute in the related table to the foreign key attribute. With reference to FIG. 10, since the attribute “name” is the first attribute that follows after the recordID atribute in supplier table 1012, this attribute “name” in supplier table 1012 is initially assigned to foreign key attribute 1004 (“Supplier_ID”) of link table 1000. Likewise, the first attribute that follows the recordID attribute in the part table 1014 is assigned to Part_ID attribute 1006 of link table 1000. Thus, the attribute “name” of part table 1014 is assigned to Part_ID attribute 1006 of link table 1000.

These assignments result in the dereferencing of the values of the foreign key attributes in the records of the link table. Thus, in the link record #1, the value 15 in the foreign key attribute field Supplier_ID is dereferenced to be the name field of record #15 of supplier table 1012, or “Acme Technologies” in the example of FIG. 10. Likewise, the value 7 in the foreign key attribute Part_ID is dereferenced to be the name field of record #7 of part table 1014, or “toothpaste” in the example of FIG. 10. Other records of link table 1000 are similarly dereferenced.

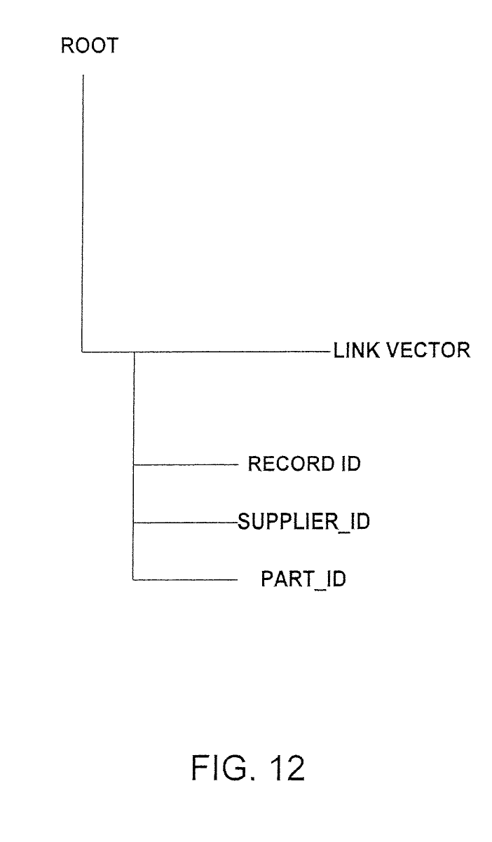

The steps of the computer-implemented method to dereference the content of a link table are shown in FIG. 11. In step 1102, a user data model is automatically generated for the link table. In one embodiment, the user data model is automatically generated by patterning it after a pre-selected user data model, with the link table represented as a child vector nodes and its foreign key attributes represented as attributes of the child vector node. An exemplary user data model for the example of FIG. 10 is shown in FIG. 12.

The general process involved in automatically generating a user data model from a table of the relational database is similar to the general process described earlier in connection with the steps for automating the development of a website. On the other hand, the user data model for the link table may also be created by the website developer using the user data model editing tool.

Once the initial user data model is created, automatic dereferencing of the foreign key attributes in the initial user data model takes place. As shown in step 1104, an arbitrarily chosen attribute in the related table is assigned to the foreign key attribute that points to that related table. In general, this arbitrarily chosen attribute is different from the record ID number attribute associated with each record of the related table. In one embodiment, this arbitrarily chosen attribute is the first attribute in the related table that comes after the record ID number attribute in the related table. This assignment process essentially dereferences the foreign key attribute in the initial user data model.

In step 1106, an optional user data model editing step is shown. In this step, the user data model dereferenced in step 1104 is presented to the website developer. Through the use of a user data model editing tool, the website developer may edit the dereferenced attribute to override the arbitrary assignment done earlier in step 1104 with a more appropriate choice of attribute or attributes from the related table. By way of example, the user data model editing tool may provide a drop-down list for each of the dereferenced foreign key attribute, which drop-down list contains the other attribute choices in the related table for the website developer to choose. If the website developer chooses more than one attribute, syntax rules tools or formatting tools may be provided to facilitate the construction of a compound dereferenced string structure. In one example, the website developer may designate that the dereferenced string structure for the foreign key attribute Supplier_ID include the name of the supplier, to be followed by the supplier's street address, a comma (a formatting structure), the city where the supplier is located, another comma, and the state in all capital letters.

After the user data model is created (and optionally edited by the website developer), a data view is generated for the user data model. This data view, along with all other generated data views associated with other link tables, may then be presented to the website developer for selection (step 1108). If a particular data view is selected, the links therefor may be inferred from the user data model associated with the selected data view and the backend logic is automatically generated (step 1110). The process associated with generating the backend logic for a selected user data model is similar to the process described earlier in connection with, for example, step 510 of FIG. 5. In step 1112, the user interface front-end is automatically generated. In this step, the data view output for a selected data view may be automatically generated on a generic webpage. Thereafter, the website developer may edit the generic web page as appropriate to create the desired web page look (step 1114).

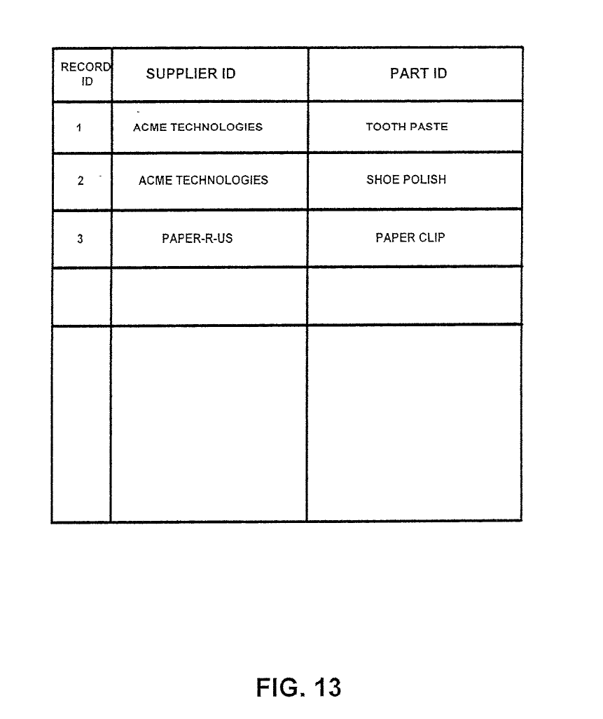

FIG. 13 shows the dereferenced version of link table 1000 of FIG. 10. In the example of FIG. 13, the dereferenced content of link table 1000 is shown simply as a matrix with the original foreign key attributes across the top row, with each link record occupying a row in the matrix. The dereferenced string structure in each row is shown under the associated foreign key attribute column.

As can be appreciated from the foregoing, the invention facilitates automatic generation of dereferenced link tables from the data schema supplied. This automatic generation is made possible by leveraging on the user data model paradigm and the earlier discussed techniques for automatic user data model generation, for initial arbitrary dereferencing of the initial user data model, and for automatic generation of backend logic and front end user interface for the selected user data model. Since the generation of the dereferenced link tables showing its contents and the relationships between attributes of the related tables occurs automatically, the costs in terms of time and expense associated with deriving the content of the link tables and presenting them in an intuitive manner to the website developer so that the website developer can more intelligently leverage on the thought process of and structure created by the database designer is substantially minimized.

In accordance with another aspect of the present invention, the foreign key from a link table to a primary table may advantageously be exploited to provide a simple and automatic way for users to drill down from a record in that primary table to obtain more detailed information contained in the link table. This aspect of the present may be better understood with the example below.

Referring back to FIG. 10, primary Supplier table 1012 is shown linked to Part table 1014 via Supplier-Part link table 1000. In connection with FIGS. 10-13, Supplier-Part link table 1000 is dereferenced by exploiting the relationship information (embodied in the foreign keys) between the link table and the primary tables linked to it. Such dereferencing resolves the content of the link table for the benefit of the website developer and/or user as discussed earlier. There are, however, times when it is desirable to permit viewing and ascertaining, directly from a page view of the content of a primary table, the number of records and/or list of records in the other primary table that relate to a particular record in the primary table under consideration.

To further elaborate, suppose a particular user would like to understand how many records relate to record #15 (“Acme Technologies”) in Supplier table 1012, or to obtain the list of records in the Part table 1014 that relates to record #15 (“Acme Technologies”) in Supplier table 1012. By way of example, a user may wish to obtain the answers to questions such as “how many parts does Acme Technologies supply?” or “what is the list of parts that Acme Technologies supply?”

In the past, the answers to such questions often involve custom programming to create a custom program to analyze Supplier-Part link table 1000. However, such a custom programming approach does not fully exploit the foreign key relationships already present in the database and thus involves unnecessary additional work, time, and/or expenses.

In accordance with one embodiment of the present invention, it is recognized that there already existed in the database specification, which is input by the database designer at the time the database is set up, information pertaining to foreign key relationships between tables. With reference to the example of FIG. 10, the database designer may indicate, at the time the database is designed, that there is a foreign key relationship between Supplier-Part link table 1000 and Supplier table 1012 using a standard database language such as SQL (Structured Query Language). An exemplary SQL structure for the example of FIG. 10 may be as follows:

```
ALTER TABLE Invoice ADD CONSTRAINT RefSupplier3
    FOREIGN KEY (Supplier_id)
    REFERENCES Supplier (Id) ;
ALTER TABLE Supplier ADD CONSTRAINT RefCategory1
    FOREIGN KEY (Category_id)
    REFERENCES Category (Id) ;
ALTER TABLE Supplier_part_link ADD CONSTRAINT RefSupplier4
    FOREIGN KEY (Supplier_id)
    REFERENCES Supplier (Id) ;
ALTER TABLE Supplier_part_link ADD CONSTRAINT RefPart5
    FOREIGN KEY (Part_id)
    REFERENCES Part (Id) ;
```

In FIG. 10, this specification is represented by arrow 1020. For a particular primary table such as Supplier table 1012, it is recognized that the existence of foreign keys that link to it, as well as the tables from which the foreign keys originate, may be readily determined by examining the database specifications of the various tables and determining whether those other tables have such a foreign key reference to Supplier table 1012. This determination may be made at, for example, build time.

At run time, executable code (e.g., Java code, specification available from Sun Microsystems, Inc. of Mountain View, Calif.), may be created automatically and employed to determine from Supplier-Part link table 1000 the number or list of parts that references a particular Supplier_ID in Supplier table 1012. By way of example, Java codes may be automatically generated and employed to determine how many records in Supplier-Part link table 1000 references record #15 (“Acme Technologies”) and/or to compile a list of those records if desired. Although Java is mentioned as a preferred executable code language, it should be noted that such is not a limitation and other suitable executable codes may also be employed.

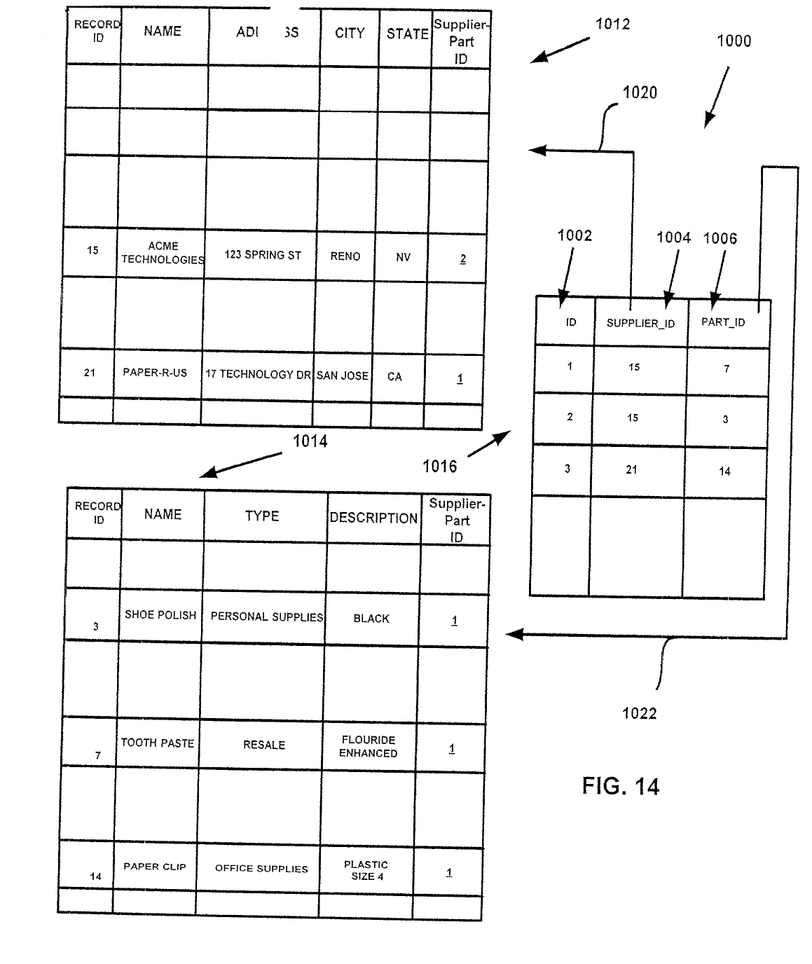

In one embodiment, the reverse referencing of foreign keys is manifested to the viewer by an automatically created additional column in the list view of the primary table (e.g., Supplier table 1012). With reference to FIG. 14, Supplier table 1012 is shown with an additional column “Supplier-Part ID”, which shows associated with each given record in Supplier table 1012 the number of records in Supplier-Part link table 1000 referring to that given record in Supplier table 1012. By way of example, the column Supplier-Part ID in Supplier table 1012 shows that Supplier #15 (“Acme-Technologies”) has 2 records in Supplier-Part link table 1000 referring to it. These two records are shown in FIG. 14 by records #1 and #2 in Supplier-Part link table 1000, which list #15 as the Supplier_ID.

In a preferred embodiment, the values provided by the additional column that implements the reverse referencing of foreign keys are preferably hyperlinks which may be acted upon by the user to obtain further information about records that underlie those values. With reference to FIG. 14, the value 2 associated with record #15 in Supplier table 1012 under the column “Supplier-Part ID” is preferably implemented as a hyperlink in the list view of Supplier table 1012 (and thus shown as an underlined number “2” in FIG. 14). This hyperlink may be automatically generated using, for example, HTML.

When the user activates the hyperlink (e.g., by clicking on it), another underlying page may be presented to furnish a list of records in Part table 1014 that actually corresponds to that foreign key value (e.g., record #15 in this example) in Supplier table 1012. The correspondence information is obtained from the link table that links Supplier table 1012 with Part table 1014, i.e., in Supplier-Part link table 1000. Such underlying page view may be automatically generated using, for example, HTML or XML and executable code (e.g., Java), and may represent a page that permits the browsing of records in the link table by the master table attribute under consideration. This page may be generated based on a preconfigured template, for example. In the example of FIG. 14, the activation of the hyperlink “2” allows a page that permits browsing of parts by supplied by supplier “Acme Technologies” to be presented. If so configured, this page view of parts by supplier “Acme Technologies” may in turn contain other columns that shows values dereferenced from foreign keys that reference the parts shown in the newly displayed page view.

In one embodiment, it is recognized that a given table (such as Supplier table 1012) may have multiple link tables with foreign keys referenced to it. By way of example, there may be a Supplier-Invoice link table that shows the relationship between the suppliers and the invoices received from those suppliers over time. In accordance with one aspect of the present invention, when there are multiple link tables to a given primary table, multiple additional columns may be added to the list view of the primary table, with each column representing the reverse foreign key resolution for one link table.

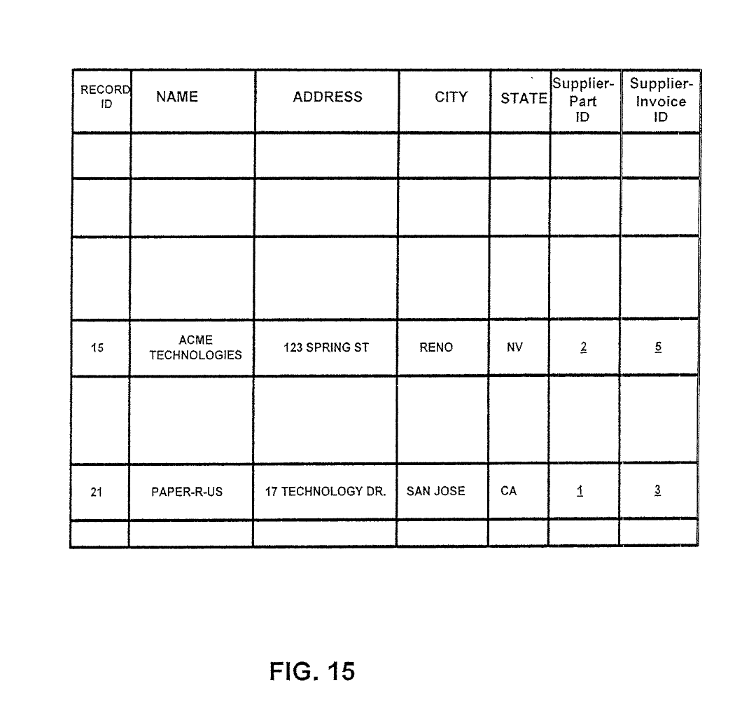

FIG. 15 illustrates, in accordance with one embodiment of the invention, this aspect. In FIG. 15, the presence of two additional columns “Supplier-Part ID” and “Supplier-Invoice ID” indicate that there are two foreign keys to Supplier table 1012. The list view of Supplier table 1012, as shown in FIG. 15, allows a user to obtain greater details pertaining to the 2 parts supplied by Acme Technologies or the 5 invoices already submitted by it (as these values have underlying hyperlink automatically created). Likewise, the view of the list view of Supplier table 1012 may activate the hyperlinks associated with Supplier Paper-R-Us to access detailed information pertaining to the 1 part supplied by Paper-R-Us or the 3 invoices already submitted by Paper-R-Us.

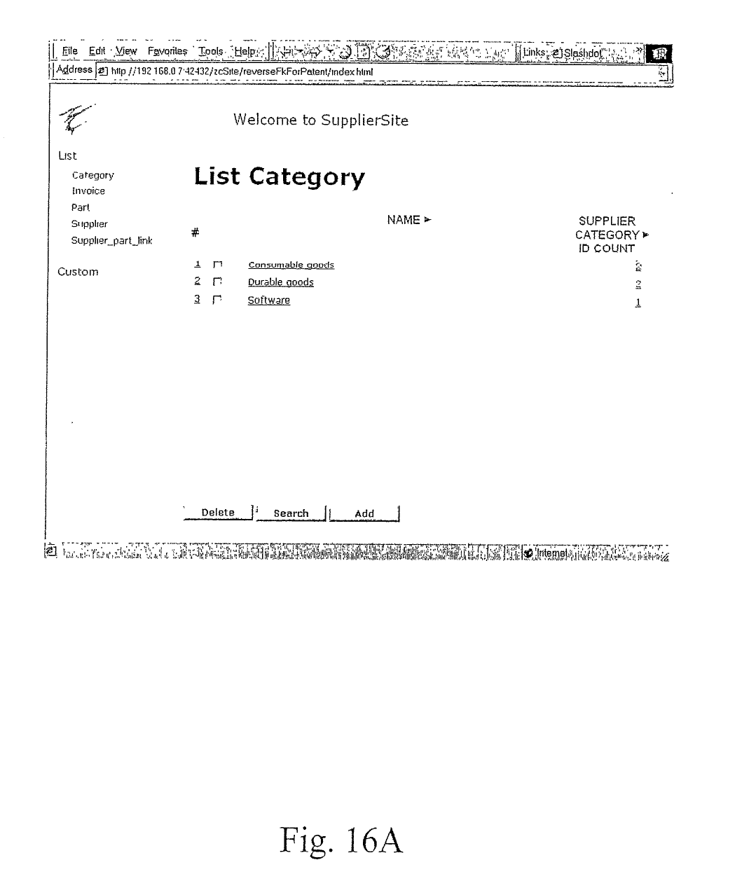

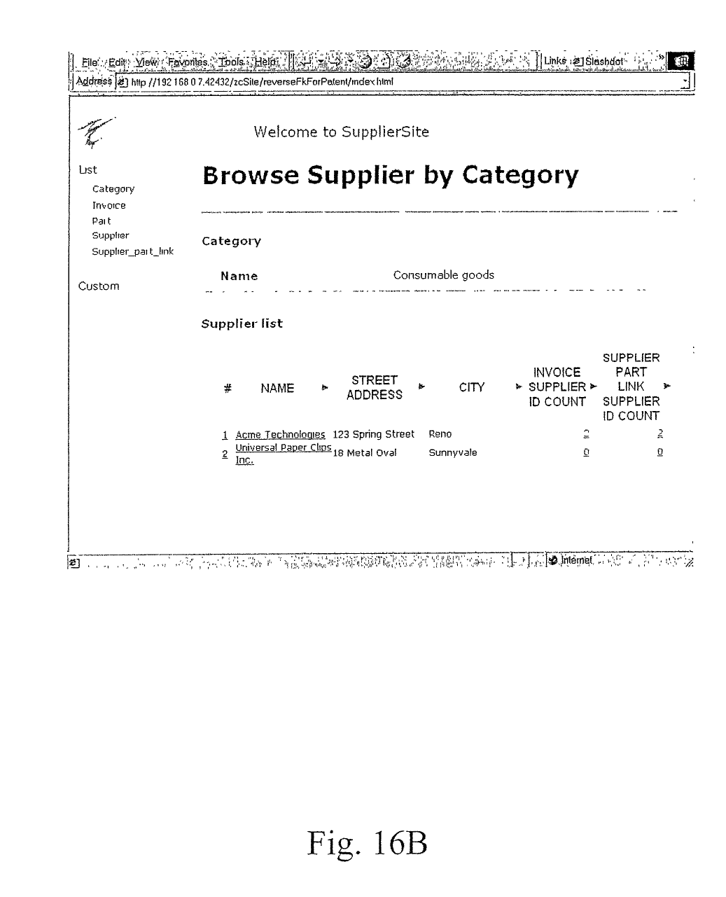

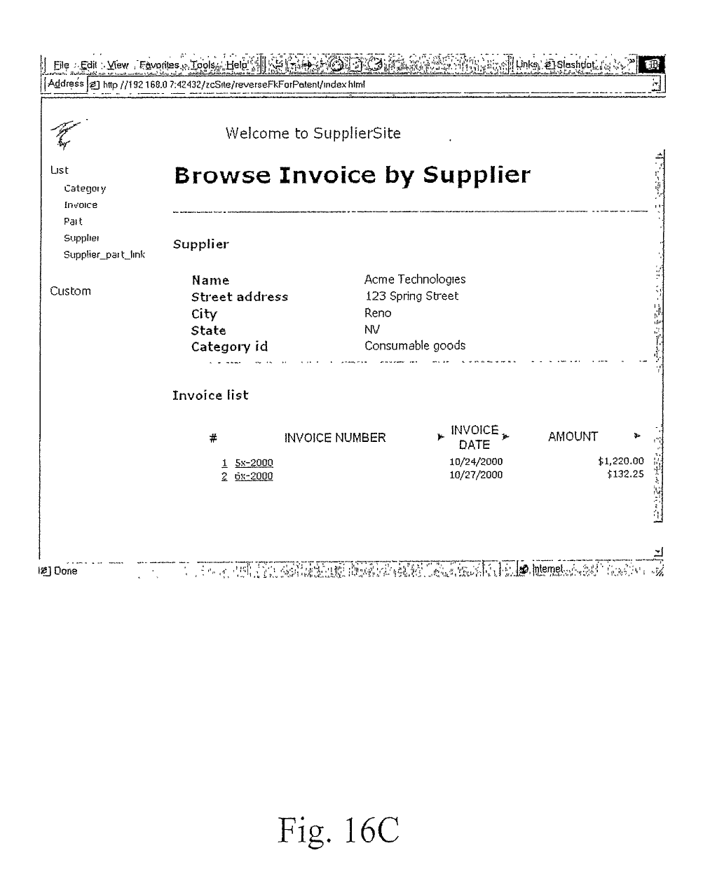

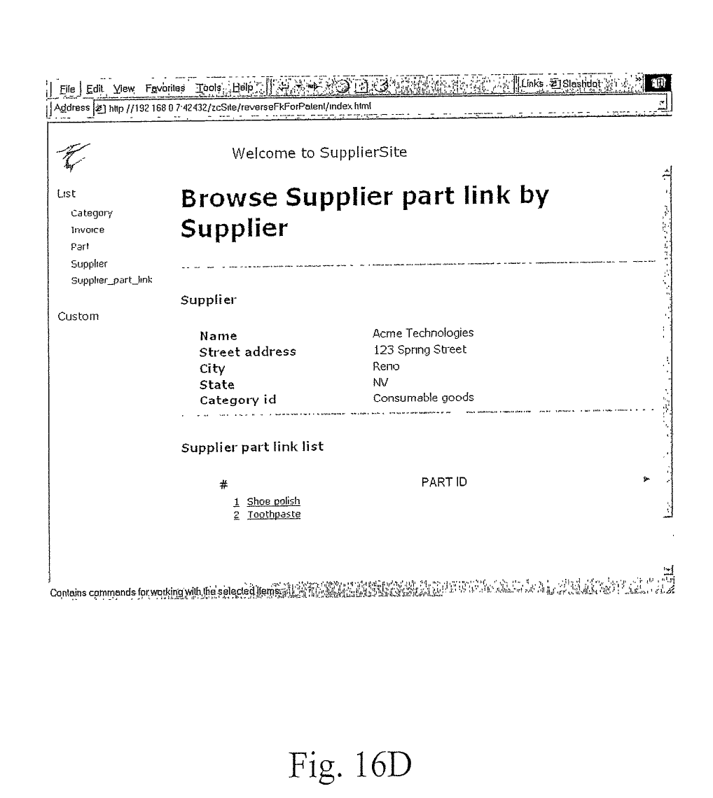

These aspects of the present invention may be better understood with reference to the examples of FIGS. 16A-16D. In FIG. 16A, a list view showing the categories supplied in the SupplierSite is shown, along with a column labeled “SUPPLIER CATEGORY ID COUNT”. This column shows associated with each record in the category table the number of records in the supplier table referring to each such record in the category table. Thus, the category “Consumable Goods” is shown referred by two suppliers (as manifested by the value 2 associated with the record “Consumable Goods.” Note that this value 2 is generated at run time by executable codes based on the determination made at build time regarding the existence of foreign key references to the Category table.

In the example of FIG. 16A, the values in the column labeled “SUPPLIER CATEGORY ID COUNT” are hyperlinks. Activating a hyperlink in this column, such as the value 2 associated with the record “Consumable Goods” will cause the list of suppliers supplying the category “Consumable Goods” to be displayed in a page view. This is shown in FIG. 16B.

Note that in the page view of FIG. 16B, the foreign keys to the Supplier IDs are also dereferenced to show that there are two invoices associated with the record Acme Technologies (as shown by the hyperlinked value “2” in the INVOICE SUPPLIER ID COUNT column) and two parts supplied by Acme Technologies (as shown by the hyperlinked value “2” in the SUPPLIER PART LINK SUPPLIER ID COUNT column). Activating the hyperlinked value “2” associated with the record Acme Technologies under the INVOICE SUPPLIER ID COUNT column causes another page view to be displayed, showing the details of the two invoices for Acme Technologies. This page view is shown in FIG. 16C. Likewise, activating the hyperlinked value “2” associated with the record Acme Technologies under the SUPPLIER PART LINK SUPPLIER ID COUNT column causes another page view to be displayed, showing the details of the two parts supplied by Acme Technologies. This page view is shown in FIG. 16D.

As can be appreciated from the foregoing, the ability to exploit the reverse foreign key reference facilitates the automatic creation of drill-down hyperlinks and access to underlying information, which allow the user to query information along the lines of thought of the database designer. Once the database designer specifies the foreign key relationship between two tables in the database, this relationship may be automatically ascertained (e.g., by search for the appropriate SQL command as discussed earlier) at build time. The relationship is then exploited at run time to create the list views presented to the user (e.g., the list view of the primary table, which includes the additional column showing the reverse foreign key referencing to permit the user, if desired, to activate the hyperlink which brings up the details of the records that references a record in the list view via foreign. The same technique applies for both automatically generated UDMs and user-specified UDMs. Since the hyperlinks, list views, page views and executable codes for obtaining detailed information from the link page are automatically generated, it is possible to furnish this capability anytime the database designer has specified a foreign key relationship between two tables without the expenses and delays associated with custom programming techniques.

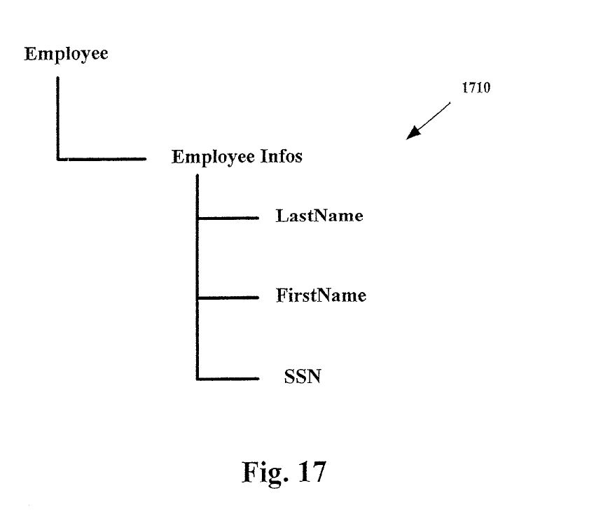

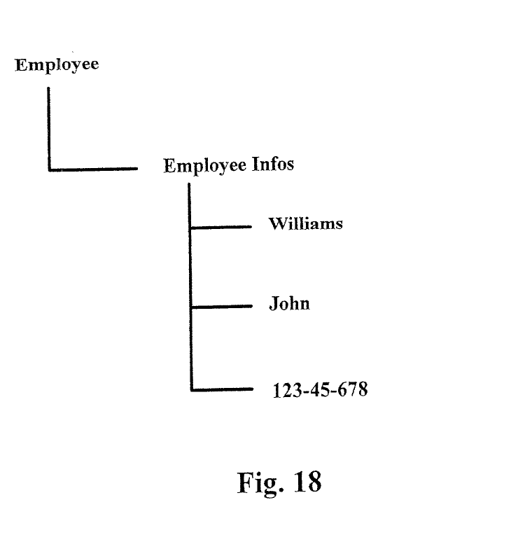

As described above, a UDM typically has a tree-like structure. Each UDM may be thought of as a blueprint for creating data structures for storing data in the database. By way of example, FIG. 17 shows an exemplary simplified UDM 1710 for storing information pertaining to employees of a fictitious organization. Data pertaining to each employee may be stored in a data structure, the organization of which is patterned after UDM 1710. That is, each leaf node of a data structure patterned after UDM 1710 (such as each of leaf nodes LastName, FirstName, and SSN) may be employed to store a piece of information (such as last name, first name, and social security number respectively ) pertaining to a given employee. For illustration purposes, FIG. 18 shows an exemplary data structure patterned after the UDM 1710 of FIG. 17, which data structure is employed for storing information pertaining to a fictional employee John Williams, as well as his social security number 123-45-6789.

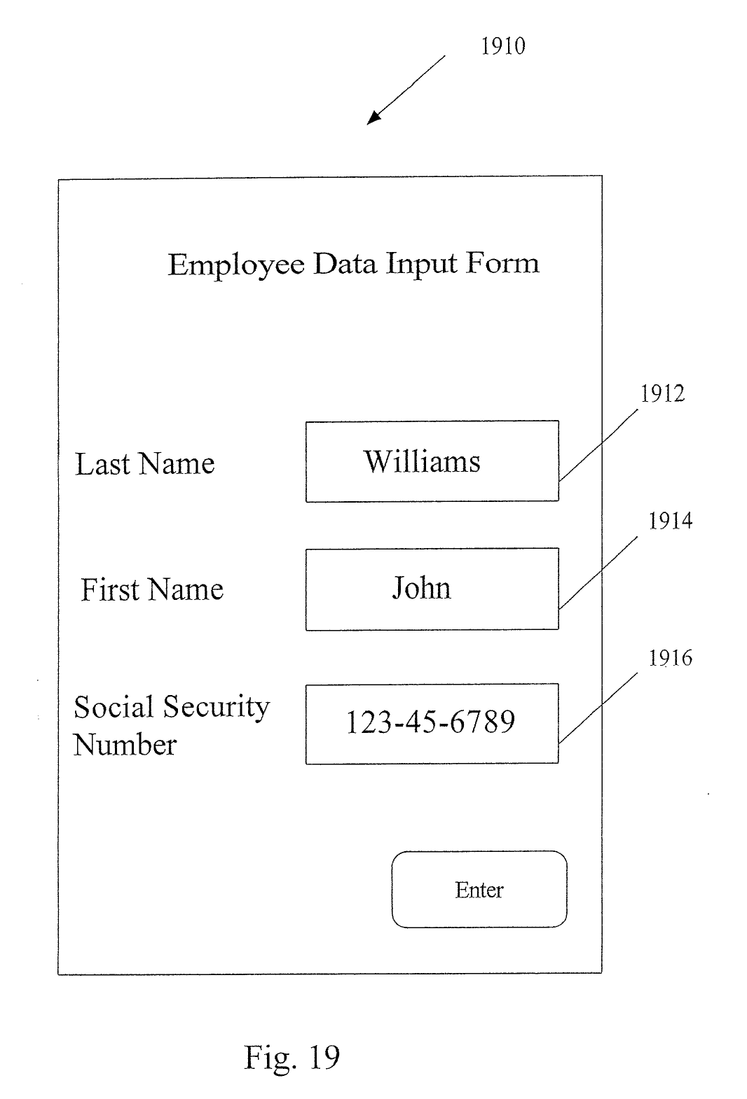

In the context of a website, a webpage is typically employed to input, edit, and/or display data. When a webpage is employed to input data (in the present discussion, inputting also encompasses editing), the various pieces of data are typically inputted into various data input fields in the data input webpage, as is conventional. By way of example, FIG. 19 shows a simplified data input webpage 1910, representing an input webpage that may be employed by a user to input employee data. Data is inputted into data input fields 1912, 1914, and 1916 using a suitable data entry mechanism, such as a computer keyboard, a voice-recognition data entry system, or the like.

After the user types in or otherwise enters the various data items, an issue arises as to how the values entered into the various data input fields of the data input webpage may be correctly mapped to the various nodes of a UDM-based data structure. The situation that often arises involves the creation of a new webpage for inputting data into an existing database with an existing UDM specification. In this case, it is imperative that the various data values obtained from the webpage be properly inserted into the various nodes of the UDM-based data structure. Otherwise, the database will be corrupted.

The problem of mapping input data values to the UDM-based data structure is exacerbated for data structures that employ lists. In a list-based data structure, a list may have many different instances of a particular data item, the exact number of which may vary dynamically. By way of example, a given employee may have two children (i.e., two instances of the “children” data item, each of which may include data such as name, sex, date of birth, and the like) while another employee may have none, or four. During data entry, the number of instances in a list is typically unknown until the user performing the data entry finishes entering all the data items in a data input webpage and hits the “send” or “save” button to save the data into the UDM-based data structures in the database. Irrespective of how many instances may be inputted, it is imperative that the data inputted into the various fields associated with each instance be accurately mapped into the UDM-based data structure in the backend.

The complication is compounded if the data structure contains nested lists (i.e., a list whose members are themselves lists). By way of example, suppose the data structure in the employee example above needs to keep track not only of the children of the employee but also the insurance status for each of the employee's children. In such a data structure, the employee list may have multiple and variable number of children instances (since different employees may have different number of children), and each children instance may have a different and variable number of insurance instances tracking health, dental, vision insurance (since different children may have different degree of coverage, with some having coverage for all three types of insurance and some having no coverage at all). UDM-based data structures may have multiple levels of nested lists, rendering them quite complex. Yet, it is crucial that the mapping from data fields of a data input webpage to the nodes of the UDM-based data structure be accurate, even for list-based data items having multiple and variable number of instances or multiple levels of nested lists.

In one embodiment of the present invention, proper mapping of the values obtained through a data input webpage is facilitated via a process that involves encoding the UDM in advance using a pre-specified encoding scheme that assigns a unique identifier to each data element of the UDM. The unique identifiers are then employed to create unique “keys” for the input data fields of the data input webpage. Each of these “keys” corresponds to one of the unique identifiers, and therefore corresponds to one of the unique data elements of the UDM on a one-to-one basis. When the user enters a value into the data input field of the data input webpage, that value entered is associated with the unique key assigned to that data input field, thereby forming a key-value pair with the key of each pair being unique. Once data entry is complete, each key is then employed to ascertain the appropriate node within the UDM-based data structure to store its associated entered data value.

In one embodiment, once the set of key-value pairs are obtained from the data input webpage, the UDM is traversed in a recursive manner starting from the root node to ascertain all the data element leaf nodes. When a data element leaf node is encountered, the unique identifier associated with that data element leaf node is employed to ascertain the corresponding unique key. For simplicity, the unique identifier and the corresponding unique key may be identical, even though they do not have to be (e.g., one can be a derivative of another). In one preferred embodiment, the unique identifier reflects the path from the root node to the data element node in the UDM tree, and that unique identifier is employed as the key associated with the corresponding data element in the data input webpage. Once the unique key is ascertained, a search may be performed through the set of key-value pairs obtained from the data input webpage to ascertain the corresponding entered data value. This entered data value, once ascertained, is then stored in the data element leaf node at the location of the corresponding unique identifier. The process continues until all data element leaf nodes are processed.

In another embodiment, the set of key-value pairs obtained from the data input webpage is traversed (the set of key-value pairs may be sorted first to improve the efficiency of the traversal process) and for each key-value pair encountered, the unique key of that key-value pair is employed to ascertain the correct node in the UDM-based data structure where the associated entered data value should be stored. Once the correct node is ascertained, the entered data value associated with that unique key is then stored in the ascertained data element leaf node. The process continues until all key-value pairs are processed.

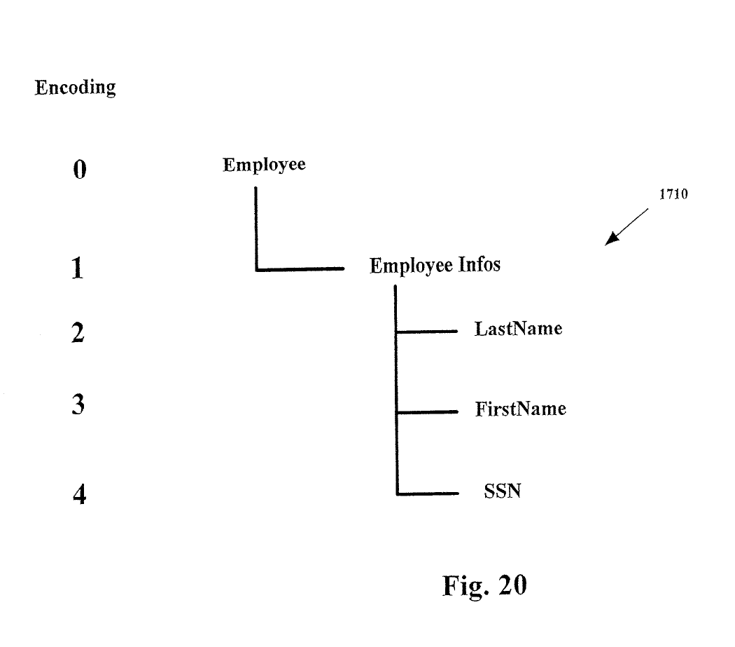

To facilitate understanding, consider again the exemplary UDM 1710 of FIG. 17. UDM 1710 represents a simple UDM that does not employ lists. As will be discussed later herein, when lists are involved, the encoding scheme must follow some specific rules in order to ensure that data mapping into data elements within the lists of the UDM tree are performed in the correct manner. In FIG. 20, the simple UDM 1710 of FIG. 17 has been encoded with a simple encoding scheme, which associates, in a sequential manner, a unique number to each node of the UDM. Thus, the data item “LastName” is represented by the identifier “0-1-2”, which represents the shortest path traversed from the root node 0, via node “Employee” (1) to the leaf node “LastName” (2). Data item “FirstName” is analogously represented by the identifier “0-1-3” and the data item “SSN” is analogously represented by the identifier “0-1-4.”

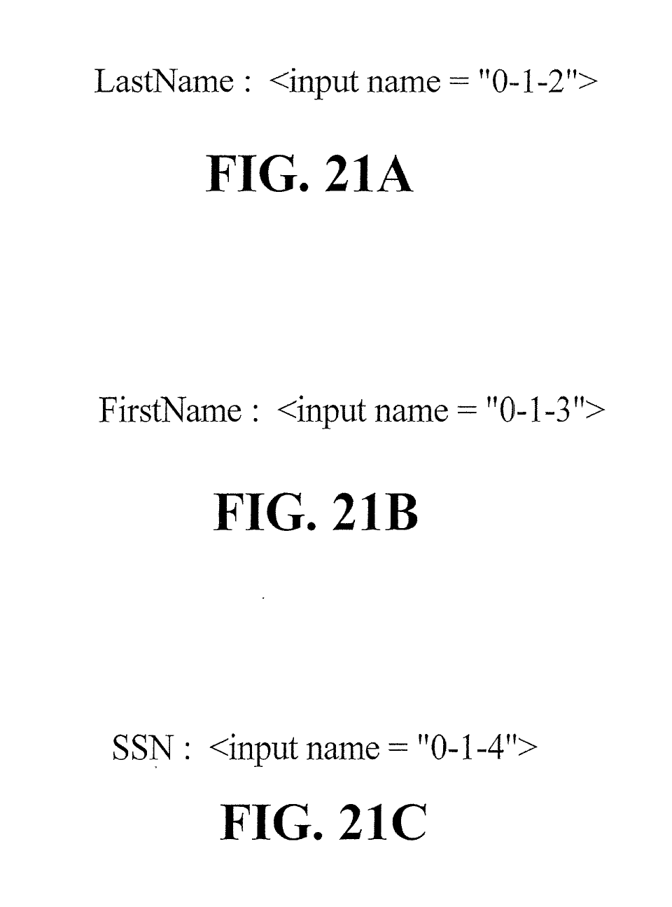

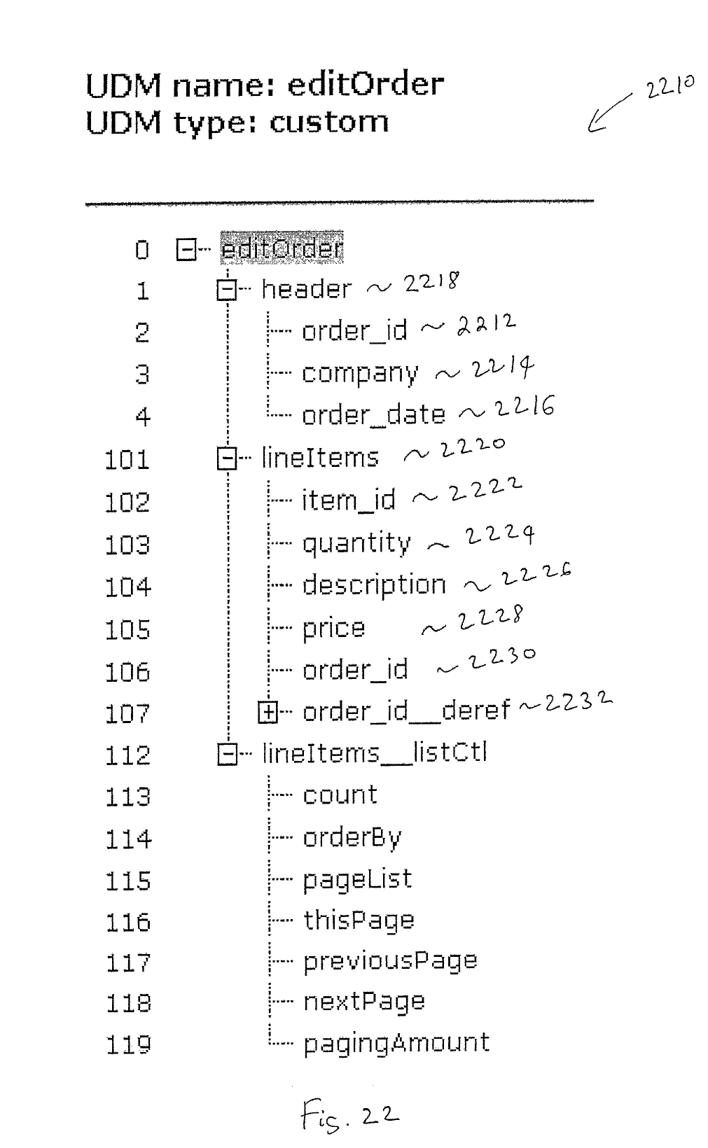

FIGS. 21a, 21b, and 21c shows the HTML code segments employed for entering data into data input fields 1912, 1914, and 1916 (Last Name, First Name, and Social Security Number respectively) of FIG. 19. As can be shown in FIG. 21a, the HTML code for entering the data value for Last Name associates the entered data value with the key “0-1-2.” As seen in FIG. 21b, the HTML code for entering the data value for First Name associates the entered data value with the key “0-1-3.” As seen in FIG. 21c, the HTML code for entering the data value for Social Security Number associates the entered data value with the key “0-1-4.” Although HTML is employed in this example, it should be kept in mind that other languages may be employed and the syntax may vary accordingly.

Subsequently, UDM 1710 is traversed from root node 0 to ascertain all data element leaf nodes. When data element leaf node LastName is encountered, its identifier “0-1-2” is then employed to search through the set of key-value pairs obtained from the data input webpage for a corresponding unique key. Since the key-value pair that contains the key “0-1-2” has associated with that key “0-1-2” the entered data value “Williams,” the data value “Williams” is stored into a UDM-based data structure that is patterned after UDM 1710, at the data leaf node whose identifier is “0-1-2” (i.e., the LastName data leaf node). The process proceeds through UDM 1710 until all data leaf nodes are processed in an analogous manner. In another embodiment, the set of key-value pairs are processed and each unique key is employed to ascertain its corresponding node the UDM-based data structure patterned after UDM 1710 . Accordingly, the key “0-1-2” will be employed to ascertain that its corresponding node in the UDM-based data structure is the data leaf node “LastName”. The data value associated with key “0-1-2”, i.e., the data value “Williams,” will be stored into data leaf node “LastName.” The process continues until all key-value pairs are exhausted.

In the example of FIGS. 21a-21c, the unique key associated with each data input field is created by combining the sub-keys representing the nodes in the UDM along the path between the root node 0 and the data item node (e.g., 2 for last name, 3 for first name, 4 for Social Security number). For simple UDM-based data structures that do not involve lists, it is not absolutely necessary to include in the unique keys information about the path between the root node and the data item node. For example, since 2 is a unique identifier for the data item “LastName”, it is possible to code this node in the HTML simply with the key “2” instead of by the full key “0-1-2.” Of course it is possible to represent this node in the key by any unique combination of number and/or letters or even binary or hexadecimal representations. As long as the encoding results in a unique identifier for each data item in the UDM-based data structure, and this unique identifier is associated on a one-to-one basis with a corresponding element in the input data webpage, any type of encoding may be employed.

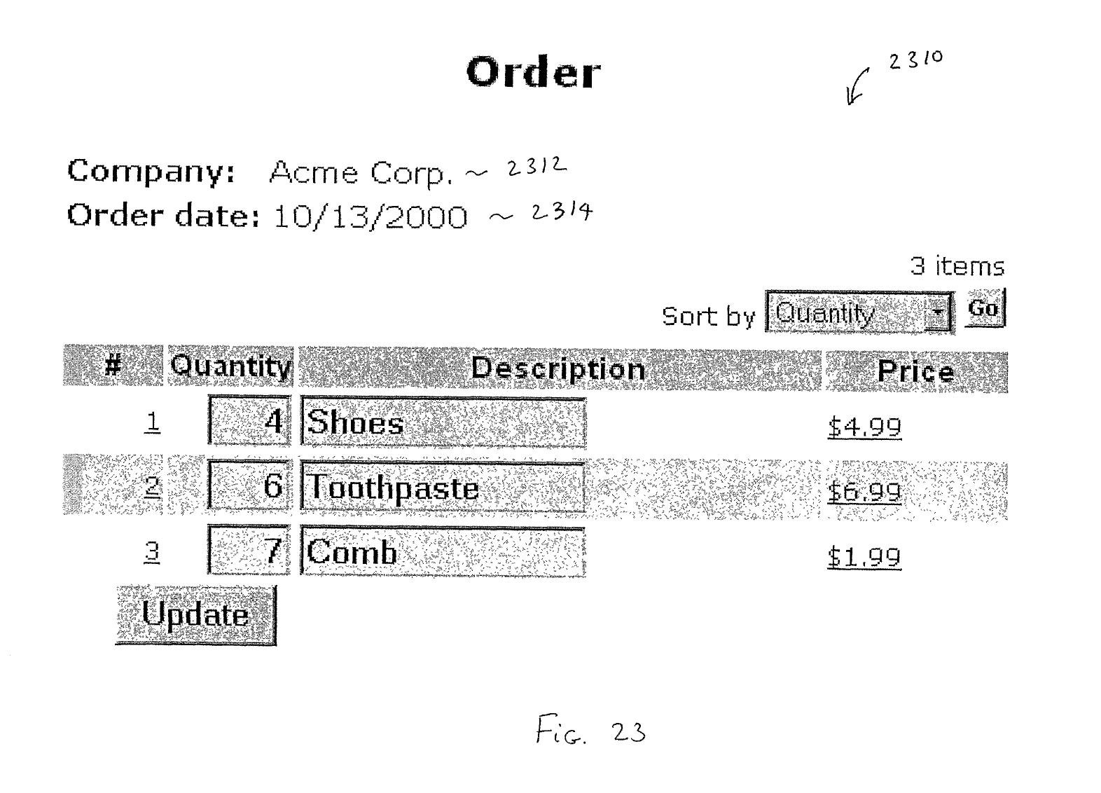

When a UDM employs one or more lists in its data structure tree, the complications associated with having lists of arbitrary depth (i.e., an arbitrary number of list elements) must be taken into account. In one embodiment, the unique key associated with each data input field is formatted such that it can store information that identifies itself as being associated with a particular instance (i.e., element) of a list. To facilitate discussion, FIG. 22 shows a UDM 2210, representing a simplified UDM for editing purchase orders. In UDM 2210, the non-list data items order_id (2212), company (2214), and order_date (2216) under the node “header” (2218) may refer to, for example, the id number of the order (which is generated for internal reference within the database system), the identity of the company making the order, and the date of the order. The latter two data items may be seen in fields 2312, and 2314 of a corresponding FIG. 23, representing the data editing webpage for editing the order associated with UDM 2210 of FIG. 22.

Referring back to FIG. 22, there is shown a list lineItems 2220, which is a list data item within UDM 2210 for storing an arbitrary number of item types ordered by the customer companies. Since each customer identified by “company” 2212 may order any combination of data items, the number of ordered item types is arbitrary. In this example, the customer Acme Corp. is seen ordering three types of items: shoes, toothpaste, and comb but another customer may order a greater or fewer number of items or the customer Acme Corp. may order a different number of items in another order with a different order_id. Each list member is an instance of the list and is represented by the data items “item_id” (2222), “quantity” (2224), “description” (2226), “price” (2228), as well as order_id (2230) and order_id_deref (2232). Order_id 2230 ties the ordered item back to the order_id 2212 wherein order_id_deref (2232) is a dereferenced node. Dereferencing has been described in an earlier patent application entitled “Content Dereferencing in Website Development” filed by the inventor herein on Jul. 20, 2001 (a/Ser. No. 09/765,058), incorporated herein by reference.

Thus, as can be seen in the screenshot FIG. 23, the first instance of the list “lineItems” has the description of “shoes”, with a quantity ordered of 4, and a price of $4.99. The second instance of the list “lineItems” has the description of “toothpaste”, with a quantity ordered of 6, and a price of $6.99. The third instance of the list “lineItems” has the description of “comb”, with a quantity ordered of 7, a price of $1.99. Note that during data entry, the number of instances may be dynamically expanded (such as when the user wishes to add an additional item type to the order), or contracted (such as when the user wishes to remove a previously entered item type from the order).

Since list involves an arbitrary number of instances, there is provided in one embodiment provisions in the coding scheme for including the instance information in the unique keys associated with the key-value pairs that contain list element data. With reference to FIG. 23, the keys associated with the descriptions “shoes”, “toothpaste”, and “comb” are encoded such that these keys are not only uniquely identifiable as being associated with the data element “description” but also are uniquely identifiable as being associated with the data element “description” of the first, second, or third instance of the list “lineItems” respectively. Likewise, the keys associated with the price values “4.99”, “6.99”, and “1.99” are encoded such that these keys are uniquely identifiable as being associated with the data element “price” of the first, second, or third instance of the list “lineItems” respectively. Similar encoding enables the keys associated with the quantity values “4”, “6”, and “7” to be uniquely identifiable as being associated with the data element “quantity” of the first, second, or third instance of the list “lineItems.”

Such encoding is challenging since, as can be seen in the UDM 2210 of FIG. 22, there is no instance information in the UDM itself, and it is unknown at the moment of data entry whether the list data element “lineItems” would have one, two, three, or more instances (at least until the user signifies that he has completed data entry). Thus, the encoding scheme must take into account the dynamic nature of lists as each data item is entered, be able to generate unique keys that also reflect how many instances are involved, and which data item belongs to which instance, and employs the information obtained during data entry to go back and build-up, from the UDM and the data entered in the various data input fields of the input webpage, the UDM-based data structure having the correct number of instances and the appropriate data values stored in the appropriate data elements of each of the instances. For UDM-based data structures containing nested lists, the challenge is compounded, necessitating a novel encoding technique.

In accordance with one embodiment of the present invention, the coding scheme encodes one or more instance counters in the unique key itself during data entry, thereby rendering it possible to keep track of the data items in lists and properly store the list data items into the UDM-based data structure. Each entered data value, if associated with a data item in a list, must have an associated unique key that includes all list items starting from the parent list item as well as the instance counter for each list. The above-discussed coding scheme may be better understood with reference to the example of FIG. 22. In FIG. 22, the nodes of UDM 2210 have been coded with the unique identifiers shown in the left column. As discussed, the data item header (2218) is not a list. Thus, the HTML input codes for its member data items order_id, company, and order_date are still as follows.

Order_id: <input name = “0-1-2”>
Company: <input name = “0-1-3”>
Order_date: <input name = “0-1-4”>

However, since lineItems (2220) is a list data element, a provision must be made to accommodate the arbitrary number instances of lineItems that may be encountered during execution. The coding scheme assigns an instance counter, starting with 0 (or 1 if desired) and increments the instance counter by one for each additional instance entered by the user. More importantly, the coding scheme associates this instance counter with the sub-identifier that identifies the list data item at issue. Thus, the HTML input code for quantity for the first instance of listItem is as follows.

Quantity: <input name = “0-101:0-103”>

With reference to FIG. 23, the key “0-101:0-103” is associated with the data input field for the quantity of the first item ordered (i.e., “shoes”). The sub-key “103” signifies that the data inputted is associated with the data element quantity, as can be seen in the encoding of UDM 2210 of FIG. 22. Note that the addition of the instance counter “0” signifies that the data being inputted is associated with the data item “quantity” of the first instance of lineItems. The association of this instance counter “0” with the data item lineItems is understood because this instance counter is associated in the key with sub-key “101”, which is the sub-key that identifies the list data item lineItems. In the example given, the construct “:” is employed to signify the association between the instance counter and its list data item. However, this construct is arbitrary and may vary dependent on the particular software/hardware platform employed.

Analogously, the HTML input codes for the data items “description” and “price” for the first instance of lineItems are as follows.

Description: <input name = “0-101:0-104”>
Price: <input name = “0-101:0-105”>

During execution, e.g., during the data entry process, if the user wishes to add another type of item to the order and enter data values therefor (another instance of lineItems), the instance counter may be incremented at that time and associated with the key (and thus associated with the list data item lineItems). This allows inputting of the data items associated with the second instance of lineItems while rendering the keys associated therewith uniquely associable with the second instance of the list data element lineItems. Thus, the HTML codes for the data items quantity, description, and price of the second instance of listItems are as follows.

Quantity: <input name = “0-101:1-103”>
Description: <input name = “0-101:1-104”>
Price: <input name = “0-101:1-105”>

With reference to the screen shot of FIG. 23, these keys “0-101:1-103”, “0-101:1-104”, and “0-101:1-105” are associated with the data input fields for the quantity, description, and price respectively of the second item ordered (i.e., “toothpaste”). The instance counter may be increased to any number to accommodate any arbitrary number of instances.

If nested lists are employed, i.e., lists whose member data items are themselves lists, the unique keys may be constructed similarly to facilitate data entry. Each list may have its own instance counter, which is associated with that list sub-key in the unique key constructed. It is important, however, that the unique key for any data item in a list has included therein the information identifying all the lists back to the parent list (i.e., the list data item that itself is not a part of another list), including the instance counter information for every list identified in the key. This ensures the uniqueness of the key for every data value entered, irrespective whether that data value is within a list or a nested list.

The above discussed coding scheme also applies to data display HTML code generated in either a data input webpage or a data display webpage. In a data display webpage (or in a section of a data input webpage), the website developer may wish for some of the data items to be displayed for viewing only, i.e., not editable. For example, the website developer may wish to create HTML code to display one or more data items in the UDM-based data structure. With reference to the example of FIG. 23, both the company name and order date are data items to be displayed. The HTML codes for displaying both the company and the order date are as follows.

Company: ${editOrder.header.company}

Order date: ${editOrder.header.order_date}

In some cases, it may be desirable to generate the data input HTML and/or the data display HTML code automatically from the UDM. When HTML code is automatically generated in a generic data input webpage or a data display webpage, the website developer may then simply edit the generic data input/data display webpage for aesthetics to obtain the desired data input webpage or data display webpage. In this manner, the complex task of creating a data input or data display webpage that can correctly store the input data values into a potentially complex UDM-based data structure is further simplified for the website developer.

In accordance with one aspect of the present invention, after the UDM is encoded with a pre-specified encoding scheme that assigns a unique identifier to each data node, a template may be automatically created. The template contains expandable template code generated for each read-only node of the UDM (i.e., each data node that contains data for display and does not require inputting by the webpage to be created) and for each read/write node (i.e., data node that can accomodate inputting/editing by the webpage to be created). Specifically, a template variable is created for each UDM node (or each instance of a UDM list node) having a read-only attribute and a tag name is created for each UDM node (or each instance of a UDM list node) having a read/write attribute. These template variables and tag names are generated at build time as the UDM is traversed from the root node to all the leaf nodes. At execution time (i.e., run time), the template variables are substituted with the read-only node values from the UDM-based data structure and the tag names are substituted with the unique keys generated at run time to enable the user to enter/edit the values for the read/write nodes.

The specific syntax for the template variables and tag names may vary depending on the HTML template expansion engine employed during run time to expand the template into actual HTML codes. In one embodiment, the FreeMarker HTML template expansion engine version 1.5 is employed (available at http://freemarker.sourceforge.net as of Nov. 13, 2001). FreeMarker is an open source HTML template engine for Java servlets and is available for download at the above-mentioned URL.

In one embodiment, the template code is automatically generated during build time using a computer-implemented method that recursively traverses the UDM and examines each leaf node of the UDM tree. For a read-only leaf node, a template variable is created to facilitate data display. For a read/write leaf node, an input tag having therein a tag name is created. The UDM is recursively traversed until all the leaf nodes are examined. In this manner, the template codes for display all the read-only data nodes of the UDM and for inputting/editing all the read/write data nodes of the UDM may be automatically generated for any UDM. The template codes may be furnished to the website developer for editing so that during run time, only the HTML codes for the desired data nodes are expanded and executed. Alternatively, the automatically generated template code may be employed during run time to automatically generate the data display and/or data editing HTML codes. The website developer may then edit the automatically generated HTML codes for aesthetics reasons, as well as to remove the HTML code sections dealing with any node that does not require displaying and/or editing.

To further understanding, exemplary simplified pseudo-codes for automatically generating data display and data entry template codes from a UDM are shown below.

1. function emitHTML (UdmTreeNode v) {
2. if (v is a leaf) {
3. if (v is read-only) {
4. // Emit the template variable for v
5. emit “${”;
6. emit v's full name;
7. emit “$}”;
8. } else {
9. // v is read-write, so emit an input tag for v
10. emit “<input name=”;
11. emit v's tag name;
12. emit “value=${”;
13. emit v's full name;
14. emit “$}>”;
15. }
16. } else {
17. if (v is a list node) {
18. emit “<table>”;
19. emit the <list> tag for v;
20. emit “<tr>”;
21. }
22. for (each child w of v) {
23. emitHTML (w); // Recursive call
24. }
25. if (v is a list node) {
26. emit “</tr>”;
27. emit “</list>”;
28. emit “</table>”;
29. }
30. }
31. }

A portion of the simplified template codes that are generated using the procedure outlined above and in accordance with the syntax required by the aforementioned FreeMarker template expansion engine is shown below. Note that reference line numbers have been added to the codes for ease of reference. In the production template codes, these reference numbers do not exist.

```
1.  <html>
2.  <head>
3.  <META HTTP-EQUIV=“Content-Type”
CONTENT=“text/html; charset=iso-8859-1”>
4.  <META NAME=“Generator” CONTENT=“ZeroCode version
V3.1B2001.10.30”>
5.  <link rel=“stylesheet” href=“/patent7/stylesheets/sample.css”>
6.  <title>Browse Items</title>
7.  </head>
8.
9.  <script>
10.  var recordNumber = 0;
11.  function showNextRecord ( ) {
12.  document.write (++recordNumber);
12.  }
14.  </script>
15.
16.  <body class=“PageBody”>
17.  <div align=“center”><h2>Order</h2></div>
18.  <form name=“mainForm” method=“post”
19.  action=“${servlet_prefix}/custom/editOrder/editAction”>
20.
21.  <table>
22.  <tr>
23.  <td>
24.  <b>Company:</b>
25.  </td>
26.  <td>
27.  ${editOrder.header.company}
28.  </td>
29.  </tr>
30.  <tr>
31.  <td>
32.  <b>Order date:</b>
33.  </td>
34.  <td>
35.  ${editOrder.header.order_date}
36.  </td>
37.  </tr>
38.  </table>
39.
40.  <table class=“ZeroCodeList” width=“100%” >
42.  <tr>
43.  <td align=“right” class=“listWhiteRow”>
44.  ${editOrder.lineItems_listCtl.count} items
45.  </td>
46.  </tr>
47.  <tr>
48.  <td align=“right” class=“listWhiteRow”>
49.  Sort by
50.  <select name=“sortSelector” style=“font-size: 7pt”>
51.
52.  <if !display_mode || display_mode[“103”] == “text”>
53.  <option value=“103”
54.  <if editOrder.lineItems_listCtl.orderBy ==
“103”>selected</if>
55.  >Quantity</option>
56.  </if>
57.
58.  <if !display_mode || display_mode[“104”] == “text”>
59.  <option value=“104”
60.  <if editOrder.lineItems_listCtl.orderBy ==
“104”>selected</if>
61.  >Description</option>
62.  </if>
63.
64.  <if !display_model || display_mode[“105”] == “text”>
65.  <option value=“105”
66.  <if editOrder.lineItems_listCtl.orderBy ==
“105”>selected</if>
67.  >Price</option>
68.  </if>
69.
70.  </select>
71.  <a border=“0” href=“javascript:doSort( )”>
72.  <img src=“/patent7/images/go_btn.gif” border=“0”
73.  style=“cursor: hand” alt=“Sort”>
74.  </a>
75.  </td>
76.  </tr>
77.  </table>
78.
79.  <table class=“ZeroCodeList” width=“100%”>
80.  <tr>
81.
82.  <th class=“TblHead”>
83.  #
84.  </th>
85.
86.  <if !display_mode || display_mode[“103”] == “text”>
87.  <th class=“TblHead” width=“7%”>
88.  Quantity
89.
90.  </th>
91.  </if>
92.
93.  <if !display_mode || display_mode[“104”] ==“text”>
94.  <th class=“TblHead” width=“58%”>
95.  Description
96.
97.  </th>
98.  </if>
99.
100.  <if !display_mode || display_mode[“105”] == “text”>
101.  <th class=“TblHead” width=“22%”>
102.  Price
103.
104.  </th>
105.  </if>
106.
107.  </tr>
108.  <list editOrder.lineItems as e101>
109.  <if cellClass101 == “listWhiteRow”>
110.  <assign cellClass101 = “listGrayRow”><else>
111.  <assign cellClass101 = “listWhiteRow”></if>
112.  <tr>
113.  <td class=“${cellClass101}” align=“right”>
114.
115.  <a
116.href=“auto/view/Items.html?id=${e101.item_id}”><script>
showNextRecord( );</script></a>
117.
118.  </td>
119.  <td class=“${cellClass101}” align=“right”>
120.
121.  <input type=“text” name=“0-101:$
                  {e101.zc_rank_}-
103”
122.  size=“3” style=“text-align: right”
123.  value=“${e101.quantity}”
124.  maxlength=“10”>
125.
126.  </td>
127.  <td class=“${cellClass101}”>
128.  <input type=“text”name=“0-101:${e101.zc_rank_}-
104”
129.  size=“15”
130.  value=“${e101.description}”
131.  maxlength=“50”>
132.
133.  </td>
134.  <td class=“${cellClass101}”>
135.  <a
136.href=““auto/view/Items.html?id=${e101.item_id}”>$
    {e101.price}</a>
137.  </td>
138.  </tr>
139.  </list>
140.  </table>
141.
142.  <table width=“98.5%” border=“0” cellpadding=“0”
      cellspacing=“0”>
143.  <tr>
144.  <td align=left>
145.  <input type=“button” value=“Update”
            onclick=“doUpdate( )”>
146.  </td>
147.  </tr>
148.  </table>
149.  </form>
150. </body>
151. </html>
```

In this exemplary template code portion, the template codes for displaying the company and order date example of the UDM of FIG. 22 would take the syntax shown on lines 24-27 and 32-35, with editOrder.header.company and editOrder.header.order_date being the two template variables.

Company: ${editOrder.header.company}
Order date: ${ editOrder.header.order_date }

The template codes for inputting Quantity are as shown on lines 121-124, with the tag name being 0-101:${e101.zc_rank_}-103. Since the data item quantity is associated with a specific instance of the list data element lineItems, this tag name 0-101:${e101.zc_rank_}-103 is then expanded during run time to allow the substitution of the variable ${e101.zc_rank_} with a counter value that represents the instance counter, thereby creating the required unique key. Thus, for the first instance of LineItems, the key generated at run time will be 0-101:0-103. With reference back to FIG. 22, this key corresponds to the path between the root node of UDM 2210 and the data item node “quantity” for the first instance of the list “lineItems”. This key will be associated with the value entered by the user to obtain the key-value pair, which may then be employed subsequently in order to store the entered value into the appropriate node position in the UDM-based data structure in the manner discussed earlier.

The template codes for inputting the data item description (lines 128-131) and the data item price (lines 138-140) are also shown above, with the tag names being 0-101:${e101.zc_rank_}-104 and 0-101:${e101.zc_rank_}-105 respectively for description and price. Analogous to the tag name for quantity, these tag names will be expanded at run time into unique keys with the proper instance numbers to facilitate inputting data for the data items description and price of each instance of the list data item lineItems.

To further understanding of the automatic HTML generation aspect of the invention, the expanded HTML codes corresponding to the portion of template codes for the above example are shown below herein. Note that reference line numbers have been added to the codes for ease of reference. In the production HTML codes, these reference numbers do not exist.

```
1.  <html>
2.  <head>
3.  <META HTTP-EQUIV=“Content-Type” CONTENT=
        “text/html;
4.  charset=iso-8859-1”>
5.  <META NAME=“Generator” CONTENT=“ZeroCode version
6.  V3.1B2001.10.30”>
7.  <link rel=“stylesheet” href=“/patent7/stylesheets/sample.css”>
8.  <title>Browse Items</title>
9.  </head>
10.  <script>
11.  var recordNumber = 0;
12.  function showNextRecord ( ) {
13.  document.write (++recordNumber);
14.  }
15.  </script>
16.  <body class=“PageBody”>
17.  <div align=“center”><h2>Order</h2></div>
18.  <form name=“mainForm” method=“post”
19.  action=“/zcSite/patent7/custom/editOrder/editAction”>
20.
21.  <table>
22.  <tr>
23.  <td>
24.  <b>Company:</b>
25.  </td>
26.  <td>
27.  Acme Corp.
28.  </td>
29.  </tr>
30.  <tr>
31.  <td>
32.  <b>Order date:</b>
33.  </td>
34.  <td>
35.  10/13/2000
36.  </td>
37.  </tr>
38.  </table>
39.
40.  <table class=“ZeroCodeList” width=“100%”>
41.  <tr>
42.  <td align=“right” class=“listWhiteRow”>
43.  3 items
44.  </td>
45.  </tr>
46.  <tr>
47.  <td align=“right” class=“listWhiteRow”>
48.  Sort by
49.  <select name=“sortSelector” style=“font-size: 7pt”>
50.
51.
52.  <option value=“103”
53.
54.  >Quantity</option>
55.
56.
57.  <option value=“104”
58.
59.  >Description</option>
60.
61.
62.  <option value=“105”
63.
64.  >Price</option>
65.
66.
67.  </select>
68.  <a border=“0” href=“javascript:doSort( )”>
69.  <img src=“/patent7/images/go_btn.gif” border=“0”
70.  style=“cursor: hand” alt=“Sort”>
71.  </a>
72.  </td>
73.  </tr>
74.  </table>
75.
76.  <table class=“ZeroCodeList” width=“100%”>
77.  <tr>
78.
79.  <th class=“TblHead”>
80.  #
81.  </th>
82.
83.
84.  <th class=“TblHead” width=“7%”>
85.  Quantity
86.
87.  </th>
88.
89.
90.  <th class=“TblHead” width=“58%”>
91.  Description
92.
93.  </th>
94.
95.
96.  <th class=“TblHead” width=“22%”>
97.  Price
98.
99.  </th>
100.
101.
102.  </tr>
103.
104.
105.  <tr>
106.  <td class=“listWhiteRow” align=“right”>
107.
108.  <a
109. href=“auto/view/Items.html?id=1”><script>showNextRecord( );</
    script></a>
110.
111.  </td>
112.  <td class=“listWhiteRow” align=“right”>
113.  <input type=“text” name=“0-101:0-103”
114.  size=“3” style=“text-align: right”
115.  value=“4”
116.  maxlength=“10”>
117.
118.  </td>
119.  <td class=“listWhiteRow”>
120.  <input type=“text” name=“0-101:0-104”
121.  size=“15”
122.  value=“Shoes”
123.  maxlength=“50”>
124.
125.  </td>
126.  <td class=“listWhiteRow”>
127.  <a href=““auto/view/Items.html?id=1”>$4.99</a>
128.  </td>
129.  <input type=“hidden” name=“0-101:0-102”
                  value=“1”>
130.  </tr>
131.  <tr>
132.  <td class=“listGrayRow” align=“right”>
133.
134.  <a
135. href=“auto/view/Items.html?id=2”><script>showNextRecord( );</
    script></a>
136.
137.  </td>
138.  <td class=“listGrayRow” align=“right”>
139.
140.  <input type=“text” name=“0-101:1-103”
141.  size=“3” style=“text-align: right”
142.  value=“6”
143.  maxlength=“10”>
144.
145.  </td>
146.  <td class=“listGrayRow”>
147.  <input type=“text” name=“0-101:1-104”
148.  size=“15”
149.  value=“Toothpaste”
150.  maxlength=“50”>
151.
152.  </td>
153.  <td class=“listGrayRow”>
154.  <a href=““auto/view/Items.html?id=2”>$6.99</a>
155.  </td>
156.  <input type=“hidden” name=“0-101:1-102”
                  value=“2”>
157.
158.  </tr>
159.
160.
161.  <tr>
162.  <td class=“listWhiteRow” align=“right”>
163.
164.  <a
165. href=“auto/view/Items.html?id=3”><script>showNextRecord( );</
    script></a>
166.
167.  </td>
168.  <td class=“listWhiteRow” align=“right”>
169.
170.  <input type=“text” name=“0-101:2-103”
171.  size=“3” style=“text-align: right”
172.  value=“7”
173.  maxlength=“10”>
174.
175.  </td>
176.  <td class=“listWhiteRow”>
177.  <input type=“text” name=“0-101:2-104”
178.  size=“15”
179.  value=“Comb”
180.  maxlength=“50”>
181.
182.  </td>
183.  <td class=“listWhiteRow”>
184.  <a href=““auto/view/Items.html?id=3”>$1.99</a>
185.  </td>
186.  <input type=“hidden” name=“0-101:2-102”
                  value=“3”>
187.
188.  </tr>
189.
190.  </table>
191.
192.  <table width=“98.5%” border=“0” cellpadding=“0”
          cellspacing=“0”>
193.  <tr>
194.  <td align=left>
195.  <input type=“button” value=“Update” onclick=
                “doUpdate( )”>
196.  </td>
197.  </tr>
198.  </table>
199.  </form>
200.  </body>
201.  </html>
```

As can be appreciated by the foregoing, the invention substantially simplifies the task of designing a webpage for inputting and/or displaying data associated with a UDM-based data structure. The encoding scheme discussed elegantly and in a simple manner associates a entered data values with the correct node within the UDM-based data structure, irrespective whether the data value entered is for a non-list data item, a data item in a specific instance of a simple list, or a data item in a specific instance of a list that is itself a specific instance of another list (i.e., nested list). Further, the ability to automatically generate a template for data inputting and/or displaying from the UDM specification during build time and to automatically generate HTML codes for data inputting and/or displaying from the template during run time essentially boils down the task of designing such a webpage to a few clicks for the website developer (apart from any editing for aesthetics). No complicated tracking of list instances or juggling with the proper insertion of data values into the UDM-based data structure is required on the part of the website developer. In this manner, the invention further simplifies this aspect of building a website and renders the process of building a website even more user-friendly, making it suitable for a wider and potentially less technically-oriented group of users.

In accordance with another aspect of the present invention, there are provided meta-templates to make the task of creating/maintaining/updating webpages substantially more efficient. Nowadays, webpages are a popular method to display text, graphics, and multimedia data on a computer display screen and to receive data input from the user. A webpage may be employed to display numerical values, textual strings, or graphical data in various fields of the webpage and/or to allow the user to input the same. A webpage may be static or dynamic. If a webpage is employed to display values, a static webpage would have the values to be displayed hard-coded into a markup language such as HTML. During execution, the browser simply reads the HTML for any formatting information, and serves up the values included with the HTML commands. On the other hand, a dynamic webpage is capable of extracting values previously stored in a database or from some other data stores and displaying the values to the user. Because the values are not hard-coded, dynamic webpages are more flexible. Dynamic webpages are useful and are indeed widely used for inputting or displaying data that needs to be stored in a database.

Templates are one way to implement a dynamic webpage. A template is essentially HTML codes (or codes in another mark-up language) that employ variables for the dynamic portions of the webpage to be created. During run-time (i.e., execution), the values from the database are substituted into the variables, using a program such as a template expander or template expansion engine, thereby allowing the webpage to display the desired value. Since templates are normally editable using an HTML editor (such as FrontPage 2000 or Dream Weaver) and reflect the familiar mark-up language approach, there is less resistance and a flatter learning curve associated with the use of templates.

To facilitate discussion, prior art FIG. 24 shows a template 2402, representing a template for generating a dynamic webpage implementable by the HTML codes 2404. During execution, the variables within template 2402 are substituted by values in database 2410 when template 2402 is expanded using a template expander 2406, such as the aforementioned FreeMarker template expansion engine. The result is HTML codes 2404, which can be displayed as a dynamic webpage by a web browser (such as Netscape by AOL Corporation of Dulles, Va. or Internet Explorer by Microsoft Corp. of Redmond, Wash.)

While templates are highly useful for creating dynamic webpages in relatively simple websites, an issue arises when a large number of templates are employed in creating the hundreds or thousands of webpages that make up a modern complex website. For many businesses and institutions, it is not unusual to have a website that is organized into a plurality of sub-sites, each of which may contain hundreds of individual webpages. By way of example, a modern corporation or a university may have different divisions or departments, each of the webpages in the different units or divisions may perform such tasks as displaying information, facilitating communication, ordering, purchasing, etc. Each of these functions, as well as each of these sub-sites, may be implemented by hundreds or thousands of individual webpages, many of which are dynamic webpages.

If the website will never be modified or updated, one can simply write a template for each dynamic page during the creation phase, and a website can very well be implemented in this manner. However, when there needs to be a change to the webpages, e.g., a change the look-and-feel of the webpages associated with a particular division of a corporation in the corporate website, each template must be individually edited to include the new HTML code. When thousands of templates are involved, this is a daunting, expensive, and time-consuming task, and is one that is prone to error as a large number of templates are modified one-by-one by the website developer.

The same problem also arises when creating and/or editing webpages that implement repeatable codes, i.e., canned codes that are required for certain housekeeping purposes such as data range checking or error checking of user-entered data, in a large number of web pages. If the website has thousands of such webpages, all of which are implemented by templates and all of which require the use of certain repeatable codes, the effort involved to implement and maintain such repeatable codes across a large number of different templates could be enormous. Despite these issues, since the template paradigm is powerful and highly useful for implementing dynamic webpages, templates are still widely used today.

In accordance with one aspect of the present invention, there is provided a meta-template mechanism for efficiently creating and managing a large number of templates of a website. In one aspect of the present invention, the meta-template mechanism is employed to control the look-and-feel of a large number of webpages. In another aspect of the present invention, the meta-template mechanism is employed to control the rendition of data, i.e., the packaging format of data for consumption by another data consumer (such as another website or program). In yet another aspect of the present invention, the meta-template mechanism is employed to implement repeatable codes across different webpages.

The meta-template mechanism advantageously leverages on the well-understood paradigm of template expansion during run time to create the dynamic webpage. However, the meta-template technique of the present invention occupies a higher level of abstraction in that it controls the generation of templates, which are in turn employed to generate the required data rendition, including the HTML rendition capable of being displayed in a web page. As the term is employed herein, a data rendition refers to the modality of data transport. HTML is one type of rendition since the data is transported in the modality specified by the HTML coding convention. XML (Extensible Markup Language) is another exemplary rendition, as is WA/IL (Wireless Markup Language), as is EDI (Electronic Data Interchange), as is the comma-delimited rendition. Other renditions exist; these are only some examples.

The meta-templates are expanded by a template expander at build-time, as opposed to run-time as in the case of template expansion into HTML as discussed earlier. A meta-template can also be expanded against any number of UDMs. The expansion of a meta-template against a number of UDMs results in templates, which are subsequently expanded during runtime as discussed earlier to form the required data renditions. The expansion of the meta-template against multiple UDMs is said to occur substantially simultaneously since once the website developer specifies the UDMs against which meta-template expansion occurs, the creation of the multiple templates can occur one right after another from the same meta-template (utilizing the multiple UDMs) without any further need for user intervention. Such creation occurs automatically unless there is some reason to stop the creation process after each template is created. Since the meta-template is at a higher level of abstraction, changes to the meta-template are propagated to the templates generated from it during build-time. In this manner, scalability is achieved since many templates can be changed simply by changing one meta-template.

Different families of meta-templates may be employed to generate different renditions. By choosing the appropriate meta-template and specifying the UDM's on which that meta-template would operate, control over both the content (via UDM selection) and the transport mechanism (since each meta-template is tailored to generate a template for a particular rendition) is achieved.

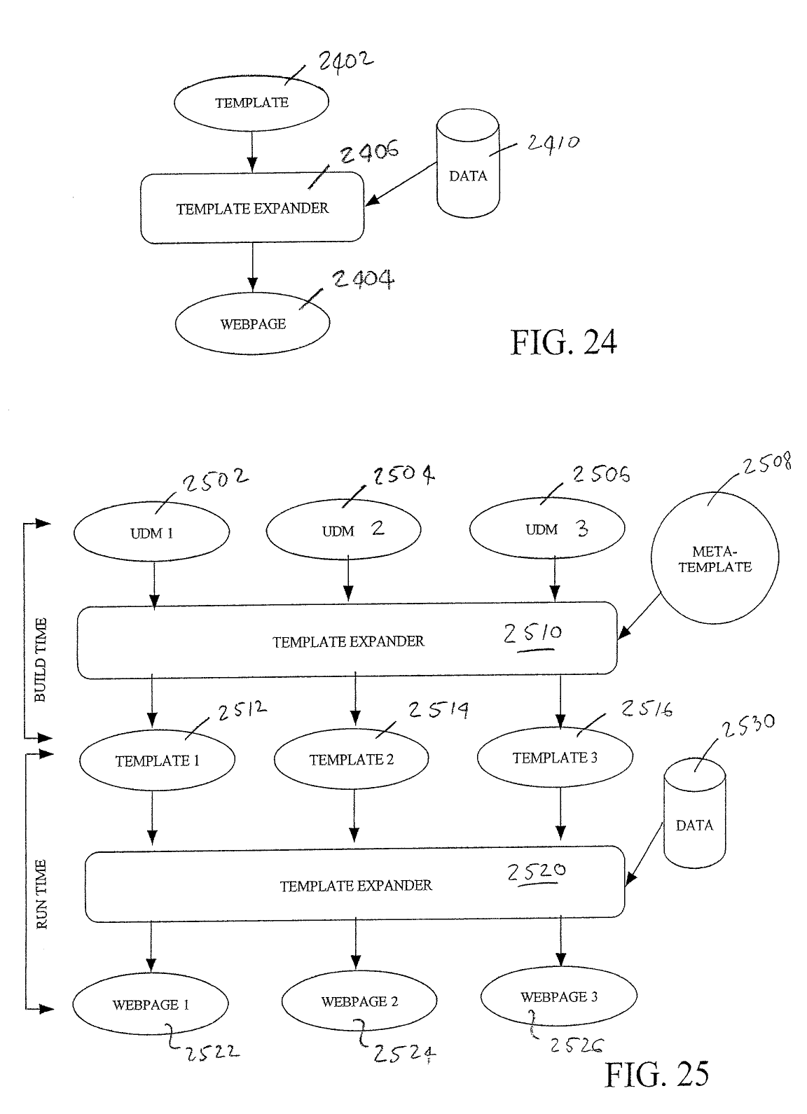

To facilitate discussion of the features and advantages of the present invention, FIG. 25 shows a conceptual view of the meta-template's role in the generation of a HTML webpage. In FIG. 25, there are a plurality of UDM's 2502, 2504, 2506, representing the user data models governing the manner with which data gets constructed or extracted. The UDM's 2502, 2504, and 2506 are inputted into a template expander 2510. A meta-template 2508 is also shown as an input into template expander 2510. Template expander 2510 employs both meta-template 2508 and the UDM's 2502, 2504, and 2506 to produce a plurality of templates 2512, 2514, and 2516 during build time. During run time, the templates 2512, 2514, and 2516 are expanded by template expander 2520, utilizing values in a database 2530, to generate three renditions 2522, 2524, and 2526. For the purpose of the present example, the renditions are in HTML. The example of FIG. 25 illustrates the power of the meta-template paradigm, as the same meta-template 2508 are expanded against three UDMs 2502, 2504, and 2506, and changes in the meta-template causes changes to be propagated to 3 other templates 2512, 2514, and 2516. Of course the number of templates may be much larger or smaller if desired.

In one embodiment, meta-temple 2508 also enforces a uniform look-and-feel for the HTML webpages generated when meta-template 2508 is expanded during build time. In this case, those HTML webpages are 2522, 2524, and 2526, which are generated during run time by expanding the three templates 2512, 2514, and 2516 respectively. In other words, since the rendition is in HTML, meta-template 2508 controls not only the data rendition (i.e., transport mechanism) but also the look-and-feel, as such is an inherent facility of HTML coding.

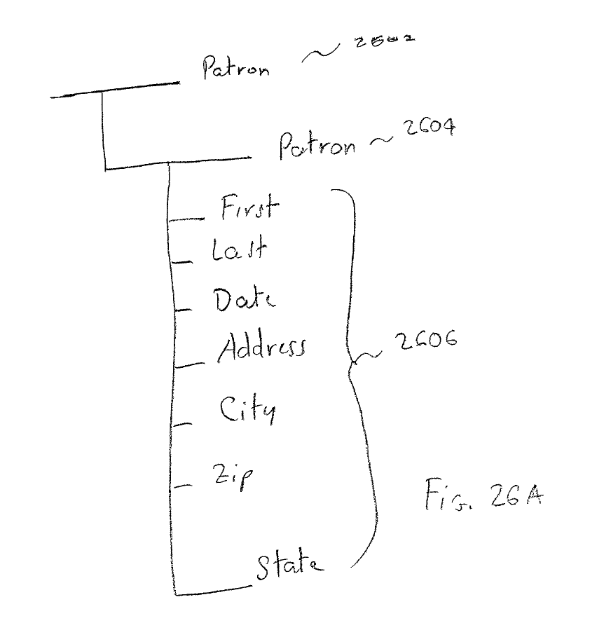

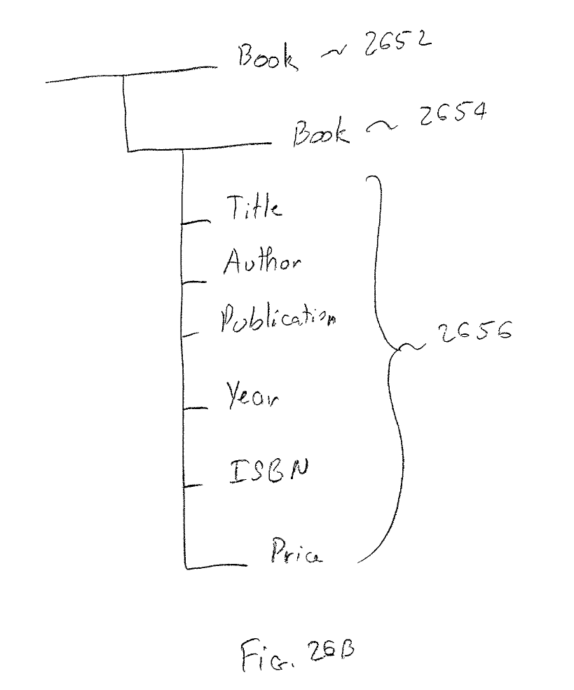

To simplify the discussion, an exemplary meta-template tailored to a UDM structure having only one non-leaf child is employed in the example below. This UDM may be, for example, an edit UDM. To facilitate discussion, suppose that there is an edit UDM for editing patron information and another edit UDM for editing book information in a public library. The edit patron UDM is as shown in FIG. 26A. In FIG. 26A, there is one root node Patron (2602), one non-leaf child node Patron (2604). Non-leaf child node Patron (2604) has a list of members, children, or attributes (2606), all of which are data leaf nodes and all of which shown as First, Last, Date, Address, City, Zip, State in FIG. 26A. Book edit UDM has a similar structure, i.e., one root node Book (2652), one non-leaf child node (2654), and a set of attributes (2656) under the non-leaf child node, but is designed for editing books is shown in FIG. 26B. These two UDMs, although designed for editing different types of data, can both be employed with a single meta-template to facilitate expansion via a template expander at build time into two templates.

The meta-template itself may simply be HTML codes interspersed with variables and tags intended for the template expander. These tags are identifiable to and acted upon by the template expander, using both the meta-template and the UDM(s) as inputs. At the simplest level, in one example, the template expander, acting on instructions laid out in the meta-template, iterates through the attribute children of the UDM tree, ascertains their types, and furnishes HTML tags and/or Java script codes (or a similar code in another language) to implement the repeatable code portions of the template. The template can then be expanded during run time to obtained the desired rendition, including HTML rendition.

Template expanders act on variables and tags embedded in the meta-template. To search for variables, a template expander simply looks for a pre-specified syntax. In the case of Freemarker, the pre-specified syntax is ${variable}. The Freemarker template expander looks for the syntax ${variable} and substitutes in values for “variables” during template expansion. If the values to be substituted in is UDM nodes from the supplied UDM tree, the expansion of a meta-template will cause a UDM-based variable (such as the name of a data field) to be substituted in during meta-template expansion. This UDM-based variable may then be substituted by an actual value when the template is again expanded during run-time against a data store.

Different tags causes the template expander to behave in different ways. By way of example, a list tag causes the template expander to look through the UDM data structure for the list whose name is given and to pull out the individual elements of the list to operate upon. The “if” tag is a conditional tag that causes the template expander to test the condition associated with a variable, and to take certain actions if the condition is met. The switch tag similarly causes the template expander to test each alternative case set forth for a match and to take certain actions depending on which alternative case has a match.

A meta-template may be tailored for a particular UDM structure. Note that there needs not be a one-to-one correspondence between a meta-template and a single UDM. Multiple UDMs may be expanded against a single meta-template, as long as they are similar structurally in term of the hierarchy of nodes in their UDM trees. However, there may be variations in the number of nodes in each level of the hierarchy, as well as in the type of data in the nodes. In one aspect of the present invention, there are generally five standard UDM structures, which can handle a large percentage of the required tasks. These are: Edit, View, List, Browse-By, and Add, Search UDMs. A meta-template family, each configured to generate a specific rendition, may be provided with one of the standard UDMs. The website developer may then edit these canned meta-templates to obtain the desired look-and-feel for his templates, or to obtain specific repeatable codes embedded in his templates.

In another embodiment, there is provided a generic meta-template that can be expanded against any UDM structure. To accomplish the flexibility associated with such a generic meta-template, there is provided a traversal algorithm to visit each node in a given UDM tree and emits the corresponding rendition code. Thus, the generic meta-template starts at the root of the UDM tree and visits each non-leaf node in turn. At each non-leaf child node, the traversal algorithm recursively visits the child and grandchild nodes, effectively implementing a recursive tree traversal.

Another key point about a meta-template is that it employs extensively the naming convention that follows the organization of the UDM, starting from the root node. In one embodiment, each node along the path between the root node and the node of interest is represented in the name; they are separate from one another by the use of a period (.). By following a naming convention that allows the meta-template to quickly access the nodes of the UDM, the process of expanding a meta-template against multiple UDMs is made substantially more efficient.

One should appreciate that meta-templates and templates are both HTML codes (or analogous codes) having tags and variables for expansion by a template expander. In this respect, they are fairly similar to one another. There are, however, many distinctions between a meta-template and a template, particularly in how they are employed. A meta-template may be expanded against as many UDMs as desired, as long as those UDMs have generally the same structure (i.e., the same hierarchy and generally the same number of non-leaf children nodes). It is this scalability that renders meta-template a powerful tool in managing a large number of webpages or other renditions. Furthermore, a meta-template is designed to be expanded during build time to generate templates. A meta-template is capable of creating variables in the templates, although it can also furnish formatting information, values, and any other facility that a template can furnish to an HTML webpage. In contrast, a template may be expanded against a database at run time to have the values from the database substituted into the dynamic part of the rendition to be created (e.g., a HTML webpage). Whereas a meta-template is designed to generate multiple templates from the multiple UDMs inputted, a template will generally be expanded into a single rendition.

In fact, the use of meta-templates enables the creation of a look-and-feel that is dynamically based on the characteristics or attributes of the data nodes, which characteristics or attributes are known at build time during meta-template expansion. For example, one may wish to create a table of patrons who registered with the library in our example. The table would list the various fields associated with the patron's UDM, e.g., first name, last name, date of birth, address, city, zip, and state ID in different columns of the table. A meta-template may be created to ascertain, at build time, the maximum number of characters allowable in each field, and to dynamically modify the width of the columns to allow each column to have a pro-rata width. The same meta-template may also be applied to a table of books, and the individual columns therein may have a different pro-rata width based on the specific characteristics of the edit book UDM. This is possible because the maximum number of characters are available at build time from the UDM and the meta-template, being HTML code, can be endowed with logic to facilitate such dynamic formatting. Such a task, while simple to perform using the meta-template paradigm, would have been impossible using, for example, CSS.

Meta-templates and the templates that are formed by them during build time are best understood with reference to a concrete example. The following code segment represents a meta-template for generating, at build time, two separate edit templates: a patron edit template for generating (at run time) the webpage that facilitates editing of patron records and a book edit template for generating (during run time) a webpage that facilitates editing of book records.

In the meta-templates below, consecutive lines of code have been annotated with consecutive numbers to facilitate ease of reference. These numbers do not appear in the production codes.

```
1.  <!DOCTYPE HTML PUBLIC “-//IETF//DTD HTML//EN”>
2.  <html>
3.  <head>
4.  <link rel=“stylesheet”
href=“/${siteName}/stylesheets/stylesheet.css”>
5.  </head>
6.  <script>
7.  function validateInteger (fieldName) {
8.  // Integer validation code goes here...
9.  }
10.  function validateDate (fieldName) {
11.  // Date validation code goes here...
12.  }
13.  function validate( ) {
14.  <list root.nonLeafChildren[“0”].children as gc>
15.  <switch gc.type>
16.  <case “int”>
17.  <if !gc.isPrimaryKey && !gc.foreignKeyToTable>validateInteger
18.  (“${gc.tagName}”);</if>
19.  <break>
20.
21.  <case “java.util.Date”>
22.  validateDate (“${gc.tagName}”);
23.  <break>
24.  </switch>
25.  </list>
26.  }
27.  </script>
28.  <body class=PageBody onload=“initialize( )”>
29.  <h2>Edit ${root.nonLeafChildren[“0”].description} Detail</h2>
30.  <assign fmList “list”><assign fmIf “if”>
    <assign oC “${“><assign cC ”}”>
31.  <assign fmElse “else”>
32.  <form method=post name=mainForm
33.  action=“${oC}servlet_prefix${cC}/auto/edit/${root.name}/
      editAction”
34.  onSubmit=“return validate( )”>
35.  <table border=“0” cellpadding=“0” cellspacing=“1”>
36.  <assign rootChildName = root.name + “.” +
37.  root.nonLeafChildren[“0”].name>
38.  <list root.nonLeafChildren[“0”].children as gc>
39.  <if gc.name != root.nonLeafChildren[“0”].
              primaryKeyName>
40.  <tr>
41.  <assign gcVal = rootChildName + “.” + gc.name>
42.  <switch gc.displayType>
43.
44.  <case “textBox”>
45.  <case “dateOnly”>
46.  <case “timeOnly”>
47.  <case “dateAndTime”>
48.  <td width=“40” class=TblHeadVertical>&nbsp;</td>
49.  <td class=TblHeadVertical>
50.  ${gc.description}
51.  </td>
52.  <td class=TblContVertical>
53.  <input type=text name=“${gc.tagName}”
54.  value=“${oC}${gcVal}${cC}”
55.  size=20 maxlength=${gc.maxChars}>
56.  </td>
57.  <td class=TblHeadVertical>&nbsp;</td>
58.  <break>
59.
60.  <case “dropDownList”>
61.  <td class=TblHeadVertical>&nbsp;</td>
62.  <td class=TblHeadVertical>
63.  ${gc.description}
64.  </td>
65.  <td class=TblContVertical>
66.  <assign optionVal = “${“ +
                    gc.listElementName + ”.id}”>
67.  <select name=“${gc.tagName}”>
68.  <${fmList} ${gcVal}_valueRange_as
69.  ${gc.listElementName}>
70.  <option value=“${optionVal}”
71.  <${fmIf} ${gc.listElementName}.id == ${rootChildName}
72.  [“${gc.name}:value”]>
73.  selected
74.  </${fmIf}>
75.  >${oC}${gc.listElementName}.
                      description${cC}
76.  </option>
77.  </${fmList}>
78.  </select>
79.  </td>
80.  <td class=TblHeadVertical>&nbsp;</td>
81.  <break>
82.  <case “none”>
83.  <break>
84.  </switch>
85.  </tr>
86.  </if>
87.  </list>
88.  </table>
89.  <input type=submit name=Submit value=Submit>
90.  </form>
91.  </body>
92.  </html>
```

Listing 1: Meta-template

The patron edit template for generating (at run time) the webpage that facilitates editing of patron records is shown below. This patron edit template is generated from the above meta-template. In this template, consecutive lines of code have been annotated with consecutive numbers to facilitate ease of reference. These numbers do not appear in the production codes.

1. <!DOCTYPE HTML PUBLIC “-//IETF//DTD HTML//EN”>
2. <html>
3. <head>
4. <link rel=“stylesheet”
5. href=“/library3ForPatent/stylesheets/stylesheet.css”>
6. </head>
7. <script>
8. function validateInteger (fieldName) {
9. // Integer validation code goes here...
10. }
11. function validateDate (fieldName) {
12. // Integer validation code goes here...
13. }
14.
15. function validate( ) {
16. validateDate (“0-1-5”);
17. }
18. </script>
19. <body class=PageBody onload=“initialize( )”>
20. <h2>Edit Patron Detail</h2>
21. <form method=post name=mainForm
22. action=“${servlet_prefix}/auto/edit/Patron/editAction”
23. onSubmit=“return validate( )”>
24. <table border=“0” cellpadding=“0” cellspacing=“1”>
25. <tr>
26. <td width=“40” class=TblHeadVertical>&nbsp;</td>
27. <td class=TblHeadVertical>
28. First name
29. </td>
30. <td class=TblContVertical>
31. <input type=text name=“0-1-3”
32. value=“${Patron.Patron.First_name}”
33. size=20 maxlength=60>
34. </td>
35. <td class=TblHeadVertical>&nbsp;</td>
36. </tr>
37. <tr>
38. <td width=“40” class=TblHeadVertical>&nbsp;</td>
39. <td class=TblHeadVertical>
40. Last name
41. </td>
42. <td class=TblContVertical>
43. <input type=text name=“0-1-4”
44. value=“${Patron.Patron.Last_name}”
45. size=20 maxlength=60>
46. </td>
47. <td class=TblHeadVertical>&nbsp;</td>
48. </tr>
49. <tr>
50. <td width=“40” class=TblHeadVertical>&nbsp;</td>
51. <td class=TblHeadVertical>
52. Date of birth
53. </td>
54. <td class=TblContVertical>
55. <input type=text name=“0-1-5”
56. value=“${Patron.Patron.Date_of_birth}”
57. size=20 maxlength=30>
58. </td>
59. <td class=TblHeadVertical>&nbsp;</td>
60. </tr>
61. <tr>
62. <td width=“40” class=TblHeadVertical>&nbsp;</td>
63. <td class=TblHeadVertical>
64. Address
65. </td>
66. <td class=TblContVertical>
67. <input type=text name=“0-1-6”
68. value=“${Patron.Patron.Address}”
69. size=20 maxlength=60>
70. </td>
71. <td class=TblHeadVertical>&nbsp;</td>
72. </tr>
73. <tr>
74. <td width=“40” class=TblHeadVertical>&nbsp;</td>
75. <td class=TblHeadVertical>
76. City
77. </td>
78. <td class=TblContVertical>
79. <input type=text name=“0-1-7”
80. value=“${Patron.Patron.City}”
81. size=20 maxlength=30>
82. </td>
83. <td class=TblHeadVertical>&nbsp;</td>
84. </tr>
85. <tr>
86. <td width=“40” class=TblHeadVertical>&nbsp;</td>
87. <td class=TblHeadVertical>
88. Zip
89. </td>
90. <td class=TblContVertical>
91. <input type=text name=“0-1-8”
92. value=“${Patron.Patron.Zip}”
93. size=20 maxlength=30>
94. </td>
95. <td class=TblHeadVertical>&nbsp;</td>
96. </tr>
97. <tr>
98. <td class=TblHeadVertical>&nbsp;</td>
99. <td class=TblHeadVertical>
100. State id
101. </td>
102. <td class=TblContVertical>
103. <select name=“0-1-9”>
104. <list Patron.Patron.State_id_valueRange_as e9>
105. <option value=“${e9.id}”
106. <if e9.id == Patron.Patron.State_id>
107. selected
108. </if>
109. >${e9.description}
110. </option>
111. </list>
112. </select>
113. </td>
114. <td class=TblHeadVertical>&nbsp;</td>
115. </tr>
116. <tr>
117. </tr>
118. </table>
119. <input type=submit name=Submit value=Submit>
120. </form>
121. </body>
122. </html>

Listing 2: Patron Edit Template

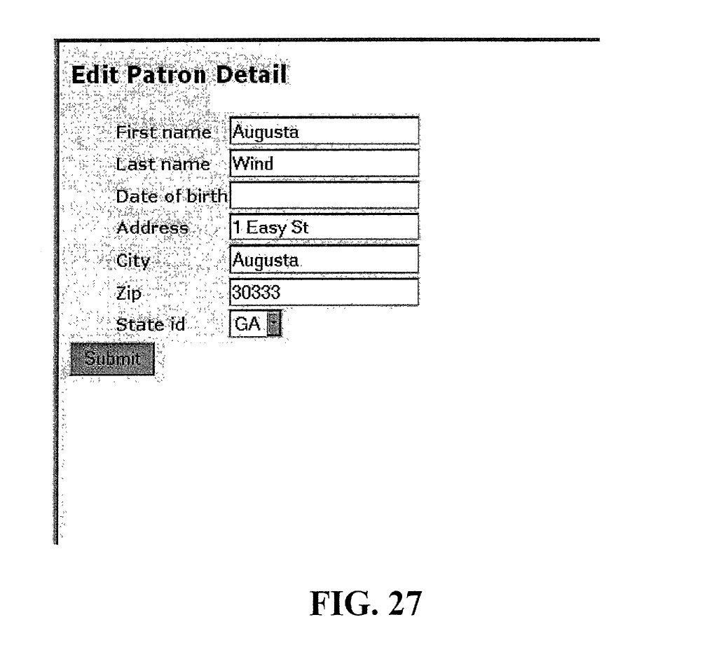

For completeness, FIG. 27 is a screen shot of the edit patron webpage (i.e., HTML) generated when the patron edit template above is furnished along with the patron data for patron Augusta Wind to a template expander engine for expansion.

A book edit template for generating (during run time) a webpage that facilitates editing of book records is shown below. This book edit template is generated from the above meta-template. In this template, consecutive lines of code have been annotated with consecutive numbers to facilitate ease of reference. These numbers do not appear in the production codes.

1. <!DOCTYPE HTML PUBLIC “-//IETF//DTD HTML//EN”>
2. <html>
3. <head>
4. <link rel=“stylesheet”
5. href=“/library3ForPatent/stylesheets/stylesheet.css”>
6. </head>
7. <script>
8. function validateInteger (fieldName) {
9. // Integer validation code goes here...
10. }
11. function validateDate (fieldName) {
12. // Integer validation code goes here...
13. }
14.
15. function validate( ) {
16. validateInteger (“0-1-6”);
17. validateInteger (“0-1-8”);
18. }
19. </script>
20. <body class=PageBody onload=“initialize( )”>
21. <h2>Edit Book Detail</h2>
22. <form method=post name=mainForm
23. action=“${servlet_prefix}/auto/edit/Book/editAction”
24. onSubmit=“return validate ( ) ”>
25. <table border=“0” cellpadding=“0” cellspacing=“1”>
26. <tr>
27. <td width=“40” class=TblHeadVertical>&nbsp;</td>
28. <td class=TblHeadVertical>
29. Title
30. </td>
31. <td class=TblContVertical>
32. <input type=text name=“0-1-3”
33. value=“${Book.Book.Title}”
34. size=20 maxlength=60>
35. </td>
36. <td class=TblHeadVertical>&nbsp;</td>
37. </tr>
38. <tr>
39. <td width=“40” class=TblHeadVertical>&nbsp;</td>
40. <td class=TblHeadVertical>
41. Author name
42. </td>
43. <td class=TblContVertical>
44. <input type=text name=“0-1-4”
45. value=“${Book.Book.Author_name}”
46. size=20 maxlength=60>
47. </td>
48. <td class=TblHeadVertical>&nbsp;</td>
49. </tr>
50. <tr>
51. <td width=“40” class=TblHeadVertical>&nbsp;</td>
52. <td class=TblHeadVertical>
53. Publisher name
54. </td>
55. <td class=TblContVertical>
56. <input type=text name=“0-1-5”
57. value=“${Book.Book.Publisher_name}”
58. size=20 maxlength=60>
59. </td>
60. <td class=TblHeadVertical>&nbsp;</td>
61. </tr>
62. <tr>
63. <td width=“40” class=TblHeadVertical>&nbsp;</td>
64. <td class=TblHeadVertical>
65. Year published
66. </td>
67. <td class=TblContVertical>
68. <input type=text name=“0-1-6”
69. value=“${Book.Book.Year_published}”
70. size=20 maxlength=10>
71. </td>
72. <td class=TblHeadVertical>&nbsp;</td>
73. </tr>
74. <tr>
75. <td width=“40” class=TblHeadVertical>&nbsp;</td>
76. <td class=TblHeadVertical>
77. ISBN
78. </td>
79. <td class=TblContVertical>
80. <input type=text name=“0-1-7”
81. value=“${Book.Book.ISBN}”
82. size=20 maxlength=30>
83. </td>
84. <td class=TblHeadVertical>&nbsp;</td>
85. </tr>
86. <tr>
87. <td width=“40” class=TblHeadVertical>&nbsp;</td>
88. <td class=TblHeadVertical>
89. Price
90. </td>
91. <td class=TblContVertical>
92. <input type=text name=“0-1-8”
93. value=“${Book.Book.Price}”
94. size=20 maxlength=19>
95. </td>
96. <td class=TblHeadVertical>&nbsp;</td>
97. </tr>
98. </table>
99. <input type=submit name=Submit value=Submit>
100. </form>
101. </body>
102. </html>

Listing 3: Book Edit Template

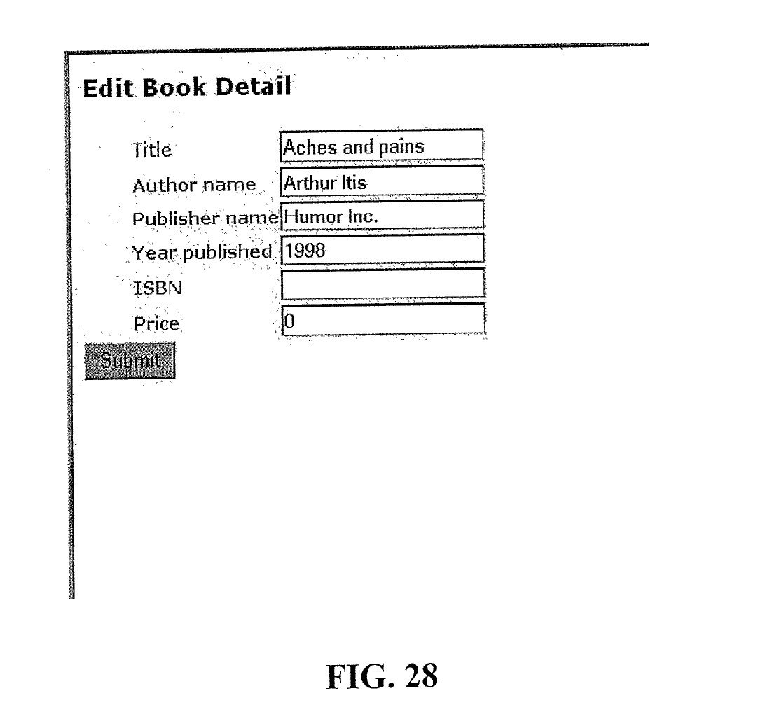

For completeness, FIG. 28 is a screen shot of the edit book webpage (i.e., HTML) generated when the book edit template above is furnished along with the book data for the book “Aches and Pains” to a template expander engine for expansion.

With reference to Listing 1, there is a list tag on line 38 <list root.nonLeafChildren[“0”].children as gc>. In these examples, gc is a running variable, and the list tag causes the children of the first non-leaf child of the root of the UDM of FIG. 26 to be treated, during meta-template expansion during build time, as part of a list of nodes. To ensure that the primary key is not displayed or changed, a check is made in line 39 <if gc.name != root.nonLeafChildren[“0”].primaryKeyName>. This is an example of the use of a conditional “if” tag to inform the template expander to take an action only if the condition for the variable (in this case, if gc.name is not a primary key) is met. Another conditional tag, the “switch” tag is shown on line 42 of Listing 1, in which the variable is checked for a possible match in various alternative cases. The cases are shown on lines 44-47 and 60.

As mentioned earlier, one of the primary advantages of a meta-template relates to the ease with which the look-and-feel of the various webpages which are generated from the meta-template's progeny templates can be changed. Because the meta-template represents a higher level of abstraction, a single point of control is furnished to modify at once tens, hundreds, or even thousands of webpages.

Suppose one wishes to change the font for the field names shown in screenshot FIGS. 27 and 28 from normal to italics. In the prior art, this would have necessitated the manual editing of each of the templates employed to generate the HTML codes that are associated with FIGS. 27 and 28, or to perform manual editing of the webpages' HTML codes themselves. Since the field names are governed by the variable gc.description (see lines 50 & 63 of Listing 1), a change to this variable in the meta-template would cause the change to propagate to all the templates generated from this meta-template. Going through Listing 1 and modifying the occurrences of the string ${gc.description} to become <i> ${gc.description} <i> accomplish this change. This change in the meta-template of Listing 1 results in an updated Patron Edit template (by expanding the meta-template at build time), which is shown below in Listing 4.

```
<!DOCTYPE HTML PUBLIC “-//IETF//DTD HTML//EN”>
<html>
<head>
      <link rel=“stylesheet”
href=“/library3ForPatent/stylesheets/stylesheet.css”>
</head>
<script>
function validateInteger (fieldName) {
    // Integer validation code goes here...
}
function validateDate (fieldName) {
    // Integer validation code goes here...
}
function validate ( ) {
    validateDate (“0-1-5”);
}
</script>
<body class=PageBody onload=“initialize ( )”>
<h2>Edit Patron Detail</h2>
  <form method=post name=mainForm
    action=“${servlet_prefix}/auto/edit/Patron/editAction”
    onSubmit=“return validate ( )”>
      <table border=“0” cellpadding=“0” cellspacing=“1”>
        <tr>
          <td width=“40” class=TblHeadVertical>&nbsp;</td>
          <td class=TblHeadVertical>
          <i>First name</i>
          </td>
          <td class=TblContVertical>
            <input type=text name=“0-1-3”
              value=“${Patron.Patron.First_name}”
              size=20 maxlength=60>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>Last name</i>
          </td>
          <td class=TblContVertical>
            <input type=text name=“0-1-4”
              value=“${Patron.Patron.Last_name}”
              size=20 maxlength=60>
          </td>
          <td class=TblHeadVertical>&nbsp;</td>
        </tr>
        <tr>
          <td width=“40” class=TblHeadVertical>&nbsp</td>
          <td class=TblHeadVertical>
          <i>Date of birth</i>
          </td>
          <td class=TblContVertical>
            <input type=text name=“0-1-5”
              value=“${Patron.Patron.Date_of_birth}”
              size=20 maxlength=30>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>Address</i>
          </td>
          <td class=TblContVertical>
            <input type=text name=“0-1-6”
              value=“${Patron.Patron.Address}”
              size=20 maxlength=60>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>City</i>
          </td>
          <td class=TblContVertical>
            <input type=text name=“0-1-7”
              value=“${Patron.Patron.City}”
              size=20 maxlength=30>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>Zip</i>
          </td>
          <td class=TblContVertical>
            <input type=text name=“0-1-8”
              value=“${Patron.Patron.Zip}”
              size=20 maxlength=30>
          </td>
          <td class=TblHeadVertical>&nbsp;</td>
        </tr>
        <tr>
          <td class=TblHeadVertical>&nbsp;</td>
          <td class=TblHeadVertical>
          State id
          </td>
          <td class=TblContVertical>
            <select name=“0-1-9”>
            <list Patron.Patron.State_id_valueRange_as e9>
              <option value=“${e9.id}”
              <if e9.id == Patron.Patron.State_id>
              selected
              </if>
            >${e9.description}
            </option>
            </list>
            </select>
          </td>
          <td class=TblHeadVertical>&nbsp;</td>
        </tr>
        <tr>
        </tr>
      </table>
    <input type=submit name=Submit value=Submit>
  </form>
</body>
</html>
```

Listing 4. Updated Edit Patron Template Resulting from a Change in Meta-Template to Italicize Field Names.

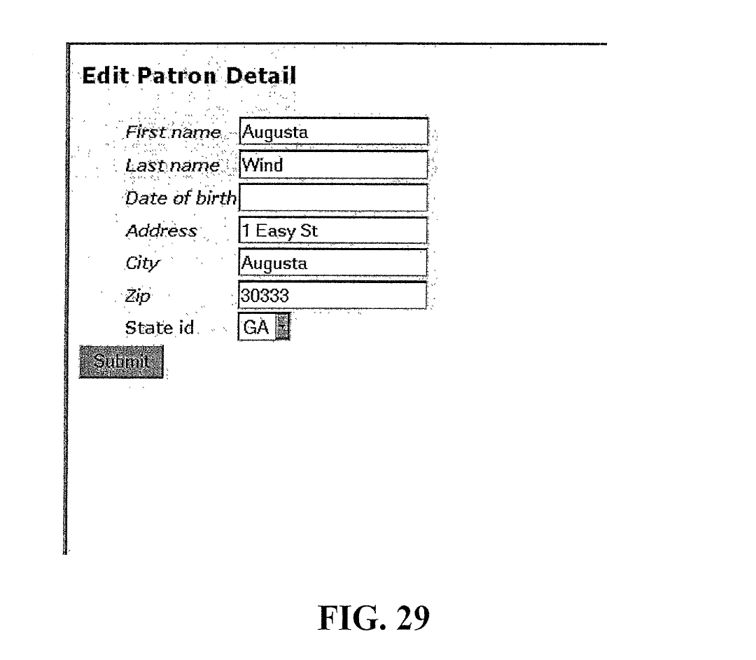

Listing 4 is obtained by expanding the new meta-template in a template expander engine, along with the UDM trees. This change in the template, which is generated from the changed meta-template, is clearly seen in FIG. 29 in which the Edit Patron HTML webpage shows the italicized field names.

The change in the meta-template also propagates to the Book Edit Template and the webpage HTML since the meta-template in the present example affects both UDMs. Listing 5 shows an update to the edit book template resulting from the aforementioned modification to the meta-template.

```
<!DOCTYPE HTML PUBLIC “-//IETF//DTD HTML//EN”>
<html>
<head>
      <link rel=“stylesheet”
href=“/library3ForPatent/stylesheets/stylesheet.css”>
</head>
<script>
function validateInteger (fieldName) {
      // Integer validation code goes here...
}
function validateDate (fieldName) {
      // Integer validation code goes here...
}
function validate( ) {
      validateInteger (“0-1-6”) ;
      validateInteger (“0-1-8”) ;
}
</script>
<body class=PageBody onload=“initialize ( ) ”>
<h2>Edit Book Detail</h2>
  <form method=post name=mainForm
    action=“${servlet_prefix}/auto/edit/Book/editAction”
    onSubmit=“return validate( ) ”>
        <table border=“0” cellpadding=“0” cellspacing=“1”>
          <tr>
            <td width=“40” class=TblHeadVertical>&nbsp;</td>
            <td class=TblHeadVertical>
            <i>Title</i>
            </td>
          <td class=TblContVertical>
            <input type=text name=“0-1-3”
              value=“${Book.Book.Title}”
              size=20 maxlength=60>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>Author name</i>
          </td>
          <td class=TblContVertical>
            <input type=text name=“0-1-4”
              value=“${Book.Book.Author_name}”
              size=20 maxlength=60>
          </td>
          </td class=TblHeadVertical>&nbsp;</td>
        </tr>
        <tr>
          <td width=“40” class=TblHeadVertical>&nbsp;</td>
          <td class=TblHeadVertical>
          <i>Publisher name</i>
          </td>
          <td class=TblContVertical>
            <input type=text name=“0-1-5”
              value=“${Book.Book.Publisher_name}”
              size=20 maxlength=60>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>Year published</i>
          </td>
          <td class=TblContVertical>
            <input type=text name=“0-1-6”
              value=“${Book.Book.Year_published}”
              size=20 maxlength=10>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>ISBN</i>
          </td>
          <td class=TblContVertical>
            <input type=text name=“0-1-7”
              value=“${Book.Book.ISBN}”
              size=20 maxlength=30>
          </td>
          <td class=TblHeadVertical>&nbsp;</td>
        </tr>
        <tr>
          <td width=“40” class=TblHeadVertical>&nbsp;</td>
          <td class=TblHeadVertical>
          <i>Price</i>
          </td>
          <td class=TblContVertical>
            <input type=text name=“0-1-8”
              value=“${Book.Book.Price}”
              size=20 maxlength=19>
          </td>
          <td class=TblHeadVertical>&nbsp;</td>
        </tr>
      </table>
    <input type=submit name=Submit value=Submit>
  </form>
</body>
</html>
```

Listing 5. Updated Edit Book Template Resulting from a Change in Meta-Template to Italicize Field Names.

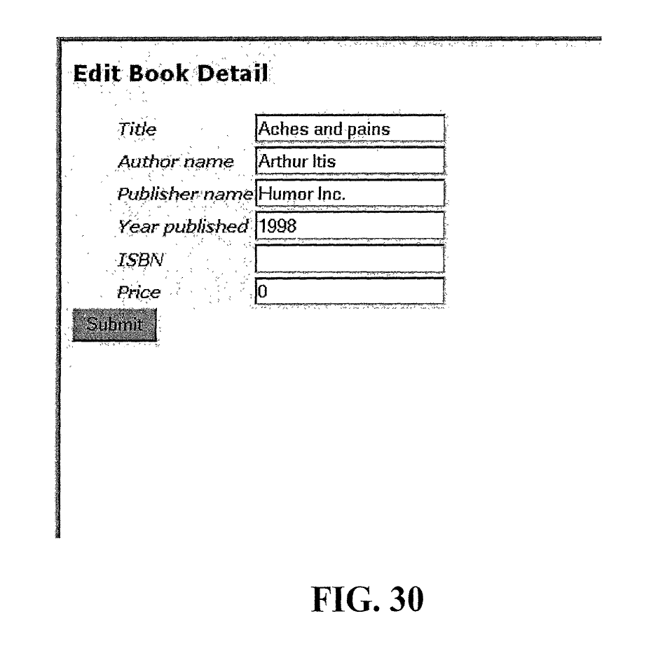

Listing 5 is obtained by expanding the new meta-template in a template expander engine, along with the UDM tree. This change in the template, which is generated from the meta-template, is clearly seen in FIG. 30 in which the Edit Book HTML webpage shows italicized field names.

Although the example above is fairly trivial, the principle applies to modifying any other look-and-feel aspects of the webpages. By way of example, tables may be changed to lists (through the UL command and by changing TR/TD to LI for the bulleted list effect). In fact, any change that can be made to the template and/or web page directly can easily be affected through the meta-template. In another example, one may wish to add background color to the data input fields in the example of FIG. 27 alternately red and white. Such a requirement, while difficult for CSS when dealing with different webpages having different number of fields, is simple when the meta-template is employed. By way of example, the list tag may be employed and the fields may be counted so that odd fields are colored with red, for example, and even fields are colored blue, for example.

Thus, by modifying one meta-template, the look-and-feel is enforced in or propagated to multiple templates that are generated therefrom. This furnishes the website designer a highly scalable and efficient mechanism for maintaining and updating the look-and-feel of a large number of webpages, including dynamic webpages, without having to resort to the time-consuming and tedious task of maintaining and updating each individual template or web page as was done in the past. Although the example shows only two templates being modified through the exemplary meta-template, it should be appreciated that any number of templates may be associated with a single meta-template to have their look-and-feel controlled thereby.

As mentioned earlier, meta-templates may also be employed to provide repeatable codes, such as data validation codes, to various templates so that the webpages generated therefrom are also endowed with the same data validation codes. As is well known, most webpages configured for inputting data are created with scripting to perform, among other tasks, data validation on the values entered by the user prior to sending those values to the server for use or storage. When a webpage is endowed with data validation codes, such data validation may be performed locally at the user's computer utilizing the user's computing resources and browser, thereby significantly speeding up the response time to the user. However, it is labor-intensive to type or cut-and-paste such repeatable codes into web page after web page, particularly considering the large number of webpages that may require data validation in a modern, complex commercial website. The prior art process, being manual in nature, is also error prone.

In accordance with one aspect of the present invention, the meta-template may be employed to provide the templates with repeatable code sections, thereby substantially reducing the amount of labor involved when creating or updating a large number of websites. Furthermore, the meta-template of the present invention may be employed to provide repeatable codes to a multitude of renditions even though the UDMs, having similar structures, may have different fields and different attributes.

In one embodiment, the meta-templates are provided with, or have access to, the sets of repeatable codes. During build time, the meta-template is expanded and the UDMs are examined so that the data attribute at each node of the UDMs against which the meta-template is expanded is ascertained. The appropriate repeatable codes will be matched to the attribute of each node requiring such repeatable codes (e.g., integer data checking for integer data nodes) and the resultant templates will be provided with the repeatable codes. In the case of data checking scripts, the data checking scripts (e.g., Java scripts) may be obtained by the meta-template from a library of templates or from codes provided with the meta-template itself.

Referring back to Listing 1, there is shown a function “validate” on line 13. On line 14, the children of the first non-leaf node are examined as list members using a list tag. Using the running variable gc, the children of the first non-leaf node are examined in turn. On lines 16-18, if gc.type is an integer (line 16) and the node is not a primary key and not a foreign key to another table, the parameter gc.tagname is passed into the validateInteger function (line 7). This validateInteger function takes the field name gc.tagname as a parameter and furnishes, in connection with that parameter, a set of java scripts for integer data checking to the resultant template. Such scripting code is conventional and not shown for brevity. The scripting code associated with gc.tagname is then provided to the template under expansion.

Similarly, if gc.type is a date (line 21) and the node is not a primary key and not a foreign key to another table, the parameter gc.tagname is passed into the validateDate function (line 7). This validateDate function takes the field name gc.tagname as a parameter and provides to the resultant template a set of java scripts for date range and data format. Such scripting code is also conventional and not shown for brevity. The scripting code associated with gc.tagname is then provided to the template under expansion.

The repeatable code generation aspect is also seen in the codes on lines 38-87 of Listing 1. On line 42, a switch tag is employed to test the display type of the running variable gc. If the display type of gc is a textbox, dateOnly, timeOnly or dateAndTime type (lines 44-47), the repeatable codes of lines 48-58 are provided to the template. On the other hand, if the display type of gc is a dropDownList (line 60), the codes of lines 61-81 are provided.

In this manner, the meta-template can provide the repeatable codes to any number of templates (and by extension, to any number of webpages) by simply writing the codes in the meta-template once and include the UDMs for the webpages requiring such repeatable codes in the meta-template expansion process. The labor intensive and error prone process of cutting and pasting as done in the prior art is no longer necessary.

As mentioned earlier, a meta-template can be tailored not only to the UDM but also to provide a particular data transport-specific rendition of that UDM. By way of example, Listing 1 shows a meta-template configured to construct HTML templates against multiple UDMs, which HTML templates can be expanded later against a data store into different HTML renditions for display. In the same manner, a meta-template can be configured to construct an XML, an EDI, or any other rendition of the UDM. In fact, this ability makes it simple to provide support for any data transport mechanism that may be required from an external system or even internal system. When there is a request for access to the database using some data transport mechanism that is new, one needs to create only one meta-template configured to expand the UDMs into templates supporting that transport mechanism. By applying such a meta-template against multiple UDMs simultaneously, the multiple templates supporting that transport mechanism can be created, and they can be expanded subsequently into the desired renditions. If a website has 10,000 webpages and that website needs to create 10,000 new renditions to deal with a different data transport mechanism, all can be done through a single meta-template, which can then be expanded using the template expander to come up with 10,000 new templates supporting the new data transport mechanism. The new templates can then be expanded during run time to create the desired renditions.

The meta-template paradigm may also be employed to generate different templates for the same group of UDMs, each of the different templates may support the same data transport but a different way of constructing the data and/or extracting the data from a data source. By way of example, a group of meta-templates may all support the XML data transport mechanism but each meta-template may be targeted to a different DTD (Document Type Definition). As another example, a family of meta-templates may all support the HTML data transport mechanism for a group of UDMs but each meta-template may be configured to produce a different look and feel. Thus, at least two knobs are provided to the website designer using the present invention: the ability to pick the content to be created (by choosing an appropriate UDM) and the ability to choose how the data in the UDM may be extracted from the data source and/or constructed. However, there is a high degree of scalability inherent in the meta-template paradigm. Once a meta-template is created, it is as easy to apply, during build time, such a meta-template against 5 UDMs to obtain five different templates (and eventually 5 different webpages) via the template expansion mechanism as it is to apply, during build time, such a meta-template against 1,000 UDMs to obtain 1,000 different templates (and eventually 1,000 different webpages) via the meta-template paradigm and template expansion mechanism.

Part of the complexity of creating and employing meta-templates, particularly in using meta-templates whose method of meta-template expansion relies on the template expander to pick up, at build time, some of the same syntax structures from the meta-template as those picked up during run-time template expansion. Some times, it is desirable for certain syntax structures to be picked up and acted upon by the template expander during run time but not during build time.

In accordance with one aspect of the present invention, the tags may be hidden from the template expander during meta-template expansion but is uncovered in the output template as a result of meta-template expansion during build time. The second time expansion occurs, i.e., on the output template during run time, the uncovered tag is acted upon by the template expander. An example of this mechanism may be seen on line 68 of Listing 1. On line 68, the tag “List” is camouflaged, or covered from the template expander during build-time meta-template expansion by the dummy variable Fmlist. During build-time meta-template expansion, the variable Fmlist is replaced by the tag “list” (see line 30 of Listing 1). Thus, the tag “list” on line 68 is uncovered after build-time meta-template expansion, to be acted upon during run time by the meta-template expander. The uncovered “list” tag is seen, for example, on line 104 of Listing 2. One should appreciate that although the tag “list” is employed in the example, any tag or variable or syntax structure capable of being acted upon by the template expander may be hidden from the build-time template expander using the same technique. In this manner, an innovative technique is provided to distinguish between tags that will be expanded during build-time and those that will be expanded during run time, further adding to the flexibility of the meta-template paradigm.

In one preferred application of the inventive meta-template paradigm, two meta-templates are employed to obtain a JSP (Java server page) or ASP (active server page) from the same UDM. When thousands of JSPs or ASPs are involved, as is the case in some complex websites, the use of a meta-template to create en masse thousands of JSPs and thousands of ASPs from the UDMs is a huge advantage for the website developer. The JSPs and ASPs are created using the same technique as generating a template for FreeMarker, except that the syntax of the variables and tags and other references to be picked up by a JSP or ASP template expander and is determined by the requirements of those platforms. In one embodiment, during build time, the website developer merely has to specify, using check boxes or a similar user interface mechanism, the UDMs to be employed for JSP/ASP generation. Another check box determines whether the pages created will be JSP or ASP. Depending on user selection, the meta-template for the JSP or ASP will be employed and applied against the chosen UDMs, and the result will be JSP or ASP templates, which may then be expanded during run time to obtain the JSPs or ASPS. Further information regarding JSPs and ASPs may be found by contacting Sun Microsystem, Inc. of Palo Alto, Calif. (sun.com) and Microsoft Corp. of Redmond, Wash. (Microsoft.com) respectively.

While this invention has been described in terms of several preferred embodiments, there are alterations, permutations, and equivalents which fall within the scope of this invention. For example, although the issues associated with the mapping of data values into UDM nodes (and vice versa) have been discussed primarily in connection with a user-input data editing webpage and a screen display webpage, those issues also apply when data is input from sources other than directly from the user and when data is output to sources other than the display screen or printer. By way of example, the same data mapping issues and the resolution thereof would apply to situations when data is input from another data source (such as another database) and when data is output to another data source. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for creating a plurality of webpages, comprising:
providing a meta-template having therein at least one of a tag and a variable;
providing a first user data model; and
expanding said meta-template against said first user data model using a first template expander, thereby obtaining a first template.

2. The computer-implemented method of claim 1 further comprising:
providing a data source;
expanding said first template against said data source using a second template expander, thereby obtaining first codes implementing a first webpage.

3. The computer-implemented method of claim 2 wherein said first template expander and said second template expander are the same.

4. The computer-implemented method of claim 1 further comprising:
providing a second user data model different from said first user data model; and
expanding said meta-template against said second user data model using said first template expander, thereby obtaining a second template.

5. The computer-implemented method of claim 4 further comprising:
expanding said second template against said data source using said second template expander, thereby obtaining second codes implementing a second webpage.

6. The computer-implemented method of claim 5 wherein said expanding said meta-template against said first user data model and said expanding said meta-template against said second user data model occurs substantially simultaneously.
